(19) United States
(12) Patent Application Publication
(10) Pub. No.: US 2010/0106575 A1
(43) Pub. Date: Apr. 29, 2010

(54) METHODS AND SYSTEMS FOR DETERMINING THE ENVIRONMENTAL IMPACT OF A CONSUMER'S ACTUAL RESOURCE CONSUMPTION

(75) Inventors: Benjamin Bixby, Washington, DC (US); Gregory O'Keeffe, Arlington, VA (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EARTH AID ENTERPRISES LLC, Washington, DC (US)

(21) Appl. No.: 12/607,959

(22) Filed: Oct. 28, 2009

Related U.S. Application Data
(60) Provisional application No. 61/109,148, filed on Oct. 28, 2008.

(51) Int. Cl. G06Q 50/00; G06Q 10/00; G06Q 40/00; G06Q 30/00

(52) U.S. Cl. 705/14.11; 705/317; 705/37; 705/400

(57) ABSTRACT

Methods, systems, apparatus, and tangible computer-readable media for receiving resource consumption information associated with a consumer from a resource consumption validator, analyzing the received information and storing the received information and/or the analysis results are herein provided. In some cases, an environmental impact associated with a consumer's resource consumption is determined. Methods, systems, apparatus, and tangible computer-readable media for automatically accessing a consumer resource consumption account and retrieving resource consumption information associated with the resource consumption account are also provided.

### CROSS-REFERENCE TO RELATED APPLICATION

This is a utility application of U.S. Provisional Patent No. 61/109,148, filed on Oct. 28, 2008 which is incorporated herein by reference in its entirety.

### FIELD OF INVENTION

The invention relates to methods, graphical user interfaces, systems and computer readable media for receiving actual resource consumption information associated with a consumer, analyzing that information, and determining an environmental impact of the consumer's resource consumption.

### BACKGROUND

Traditionally, resource consumers have multiple resource consumption accounts with multiple resource consumption providers and/or resource consumption validators. Exemplary resources consumed by the consumer include electricity, natural gas, and water. Many resource consumption providers/validators now offer online resource consumption account management. However, when a consumer wishes manage their overall resource consumption, they are required to log into each resource consumption account individually. This lack of centralized management of a consumer's resource consumption accounts creates a cumbersome and inefficient resource consumption management scheme for the consumer at least because the consumer must log into each account individually and information is not readily transferable between accounts in an automated fashion. Additionally, the information provided via an online consumption account with a resource consumption validator provides no clear indication of an environmental impact of a consumer's resource consumption, ways for a user to reduce their resource consumption, and/or reduce the environmental impact of that resource consumption.

Schemes exist and are developing to, for example, regulate, recognize, and/or monetize resource consumption and conservation of resource consumption. Exemplary schemes include a cap and trade scheme, a carbon exchange scheme, a resource conservation scheme, a ranking scheme of environmentally sensitive resource consumers (e.g. Newsweek's “Green Ranking” of companies), and a pollution reduction scheme. Conventionally, participation in these schemes is limited to large entities because the scale of resource consumption by an individual consumer is too small to be of statistical significance when compared with the resource consumption of large entities. Therefore, individual consumers have traditionally been excluded from participation in such schemes. Thus, any increase in an individual consumer's conservation of resources is unmeasured and they suffer a loss of any benefit, economic, or otherwise, offered by participation in such a scheme. Furthermore, denying participation to individual consumers in these schemes also deprives the consumers of the incentive provided by participation in the scheme and therefore removes an incentive for individual consumers to conserve their individual resource consumption.

Therefore, a need exists for centralizing the management of a consumer's resource consumption accounts and increasing consumer participation in schemes involving the regulation, monetization, and recognition of resource consumption and conservation of resource consumption.

### SUMMARY

Methods, systems, apparatus, and graphical user interfaces (GUI) for receiving actual resource consumption information associated with a consumer from a resource consumption validator are herein provided. In some cases, the received information may be analyzed and the received information and/or analysis results may be stored in a data store.

The stored analysis results may be accessed by, for example, a third party computer system. A third party computer system may be any computer system enabled to perform the methods described herein that is not directly operated by a consumer or a resource consumption validator. Once the stored analysis results are accessed they may be analyzed to determine an environmental impact caused by the resource consumption. Exemplary types of environmental impacts include the amount of pollution generated by a consumer's resource consumption and the amount of pollution generated by producing, transmitting, transporting, and/or selling the consumed resource, such as a quantity of carbon dioxide and/or other toxins released into the atmosphere or ground water as a direct or indirect result of the consumer's resource consumption.

In some embodiments, the determined environmental impact from two or more consumers may be aggregated. The aggregate may be packaged such that it may be sold on a market such as a carbon exchange and/or resource exchange and/or via a cap and trade system. A portion of the proceeds from the sale may be returned to the consumer via, for example, a third party computer system. The portion of the proceeds from the sale may be a monetary amount deposited into an account and/or a non-monetary reward such as bonus points exchangeable for goods and services, and other commodities, including but not limited to, frequent flyer miles, or a donation to a charity.

In one embodiment, historical resource consumption information associated with the consumer may be received from the resource consumption validator by, for example, a third party computer system. A difference between the consumer's actual resource consumption and their historical resource consumption may then be calculated. Using this difference a reward may, in turn, be calculated for the consumer. The calculated reward may then be returned to the consumer via, for example, a third party computer system.

In some embodiments, a statement relating to the consumer's resource consumption may be prepared for, and delivered to, the consumer. Exemplary information included in the statement can include current, estimated, and historical resource consumption information, target resource consumption information, advice concerning conserving resource consumption and/or a reward or a portion of the proceeds from a sale of the resource conservation that the consumer has earned via, for example, their resource consumption conservation or participation in a resource conservation scheme. One or more messages may be included in the statement. In some instances, the statement may be a tangible, or paper, statement and may be provided to a consumer via, for example, a postal delivery service. In these instances, the message may be included in the statement or provided to the consumer in addition to the statement. Statements may also be intangible and may be, for example, telephonic or electronic and may be delivered via a telephone, an email message, and/or a text message. When statements are intangible, a message may be included as a portion of, or be appended to, the statement. Exemplary messages can include advice for conserving resources, news about resource consumption, advertisements, and/or graphs or tables related to the resource consumption.

In another embodiment, a scheme may be provided to the resource consumption validator wherein adoption of the scheme enables the resource consumption validator to mitigate a liability associated with, for example, a regulatory scheme affiliated with the consumption of the resource the resource consumption validator validates. The scheme may also enable the resource consumption validator to engage in an economic opportunity associated with the consumption of and/or conservation of the resource the resource consumption validator validates. A portion of any benefit gained by the resource consumption validator from enablement of the scheme may be returned to, for example, the resource consumption validator and/or the consumer. Exemplary benefits can include financial earnings or savings, a mitigation of liability under a regulatory scheme, and recognition of resource conservation.

In yet another embodiment, the received actual resource consumption information may be transmitted by, for example, a third party computer system, to an outside party, such as a governmental entity or resource conservation entity. The outside party may use, for example, the received actual resource consumption information, to generate, manage, and/or distribute, for example, a feature set and/or a software program relating to, for example, resource consumption conservation. The feature set and/or software program generated by the outside party may be provided to the consumer via, for example, a computer system. Exemplary software programs and feature sets can include online resource management accounts, widgets, and software applications for mobile devices, such as mobile phones. In some cases, the actual resource consumption information may be initially received by, for example, a third party computer system at the request of the outside party.

In a further embodiment, the received actual resource consumption information may be analyzed to, for example, determine a cost associated with a consumed resource when it is validated by a particular resource consumption validator. Exemplary costs can include a financial cost and an environmental cost or impact.

The determined cost associated with the consumed resource may then be compared with a potential cost associated with the resource consumed when the resource is validated via an alternative resource consumption validator to produce comparison results. These comparison results may be provided to the consumer. On some occasions, the consumer may be provided an opportunity via, for example, a third party computer system, to switch from the resource consumption validator to the alternate resource consumption validator. On these occasions, the consumer may terminate resource consumption validation with the resource consumption validator and activate resource consumption validation with the alternative resource consumption validator.

In yet another embodiment, a resource consumption account with a resource consumption validator may be automatically accessed by, for example, a third party computer system, via an online account management system associated with the resource consumption validator. The resource consumption account may be associated with a consumer. Actual resource consumption information associated with the consumer, an estimate of a consumer's actual resource consumption, and/or historical resource consumption information associated with the consumer may then be retrieved from the online account management system.

On some occasions, automatically accessing the resource consumption account may require entry of the consumer's registration information into the online account management system. On these occasions, consumer registration information associated with the resource consumption account may be received from, for example, the consumer, an agent of the consumer, and/or the resource consumption validator and may be provided to the online account management system thereby enabling the automatic access to the resource consumption account by, for example, a third party computer system.

Exemplary GUIs provided herein enable the receipt of consumer registration information, receipt of information from a consumer regarding one or more resource consumption accounts the consumer has with a resource consumption validator, the providing of an environmental impact of the consumer's resource consumption associated with the resource consumption account to the consumer, and the providing of information regarding a reward and/or a portion of proceeds due to the consumer based on the determined environmental impact to the consumer.

A computer readable media may include instructions that may enable a machine to receive actual resource consumption information associated with the consumer from a resource consumption validator, analyze the information by a third party computer system, determine an environmental impact of the consumer's resource consumption based on the analysis results and store the received information, the results of the analysis and the determined environmental impact.

### BRIEF DESCRIPTION OF THE DRAWINGS

The application is described by way of examples with reference to the accompanying drawings, wherein:

FIG. 1 is a block diagram illustrating a system enabled to determine an environmental impact of a consumer's resource consumption, consistent with some embodiments of the invention;

FIG. 2 is a screenshot of an exemplary page showing a GUI for accessing a resource consumption validation account, consistent with some embodiments of the invention;

FIG. 3 is a screenshot showing an exemplary GUI for account creation, consistent with some embodiments of the invention;

FIG. 4 is a screenshot of a GUI for entering a consumer's location information, consistent with some embodiments of the invention;

FIG. 5 is a screenshot of an exemplary GUI for entering resource consumption validator account information, consistent with some embodiments of the invention;

FIG. 6 is a screenshot of an exemplary GUI for including information regarding two resource consumption accounts, consistent some with embodiments of the invention;

FIG. 7A-7F are exemplary screenshots of GUIs including a statement prepared for the consumer, consistent with some embodiments of the present invention;

FIGS. 8A and 8B are screenshots of exemplary GUIs including advice for resource conservation, consistent with some embodiments of the present invention;

FIG. 9 is a screenshot of an exemplary GUI including a statement of a consumer's resource consumption;

FIG. 10 is a flow diagram illustrating a process for determining an environmental impact of a consumer's resource consumption, aggregating, packaging, and/or selling the environmental impact of two or more consumers, consistent with some embodiments of the invention;

FIG. 11 is a flow diagram illustrating a process for retrieving, parsing, and/or categorizing current and/or historical actual resource consumption information, consistent with some embodiments of the invention;

FIG. 12 is a flow diagram illustrating a process for determining an environmental impact of a consumer's actual resource consumption consistent with some embodiments of the invention;

FIG. 13 is a flow diagram illustrating a process for determining a resource saving recommendation for a consumer, and/or delivering a statement to the consumer, consistent with some embodiments of the invention;

FIG. 14 is a flow diagram illustrating a process for packaging and/or selling information related to the resource consumption of a consumer, consistent with some embodiments of the invention;

FIG. 15 is a flow diagram illustrating a process for determining a message for a consumer, consistent with some embodiments of the invention;

FIG. 16 is a flow diagram illustrating a process for automatically accessing consumer resource consumption account information, consistent with some embodiments of the present invention;

FIG. 17 is a flow diagram illustrating a process for automatically accessing consumer resource consumption account information and providing a scheme to a resource consumption validator, consistent with some embodiments of the present invention;

FIGS. 18A and B are an exemplary tables illustrating the resource consumption of a consumer over a period of time, consistent with some embodiments of the invention;

FIG. 19 is a flow diagram illustrating a process for transmitting received actual resource consumption information to an outside party, consistent with some embodiments of the present invention; and

FIG. 20 is a flow diagram illustrating a process analyzing received actual resource consumption information and determining a cost associated with the resource consumed, consistent with some embodiments of the present invention.

### DETAILED DESCRIPTION OF THE INVENTION

Methods, systems, apparatus, and tangible computer-readable media for determining the environmental impact of a consumer's actual resource consumption are provided.

According to an embodiment, actual resource consumption information for a consumer may be received. The information may be received from a resource provider, a resource consumption validator, or validating service such as a utility company of governmental agency. The information may then be analyzed to determine the environmental impact of the consumer's resource consumption.

On some occasions, actual resource consumption information may be received from two or more consumers. In this instance, the determined environmental impact of the two or more consumers may be aggregated together. The aggregate may then be packaged into, for example, something that can be sold, such as a carbon credit. The package may then be sold on a market, such as a commodities exchange or a private market via, for example, a bilateral contract. In one embodiment, a portion of the proceeds from the sale may be returned to the consumer via, for example, a paper check or electronic funds transfer.

In one embodiment, a statement including information regarding the consumer's resource consumption may be prepared for the consumer. The statement may be sent to the consumer via, for example, an email, SMS text message or paper statement delivered through the U.S. Postal Service. On some occasions, the consumer is enabled to directly access his statement without it being sent to him. On these occasions, the consumer may access the statement by, for example, logging into a web site or access portal. In one embodiment, a message may be associated with the statement. A message may include, for example, an advertisement or recommendation for resource conservation.

A resource may be, for example, a good, service, or commodity that may be consumed by one or more consumers. Exemplary resources include electricity, natural gas, water, food, raw materials, minerals, metals, paper, oil and other refined petroleum products like gasoline, and wood. A consumer may be any individual, entity, business, governmental agency, or organization that consumes a resource.

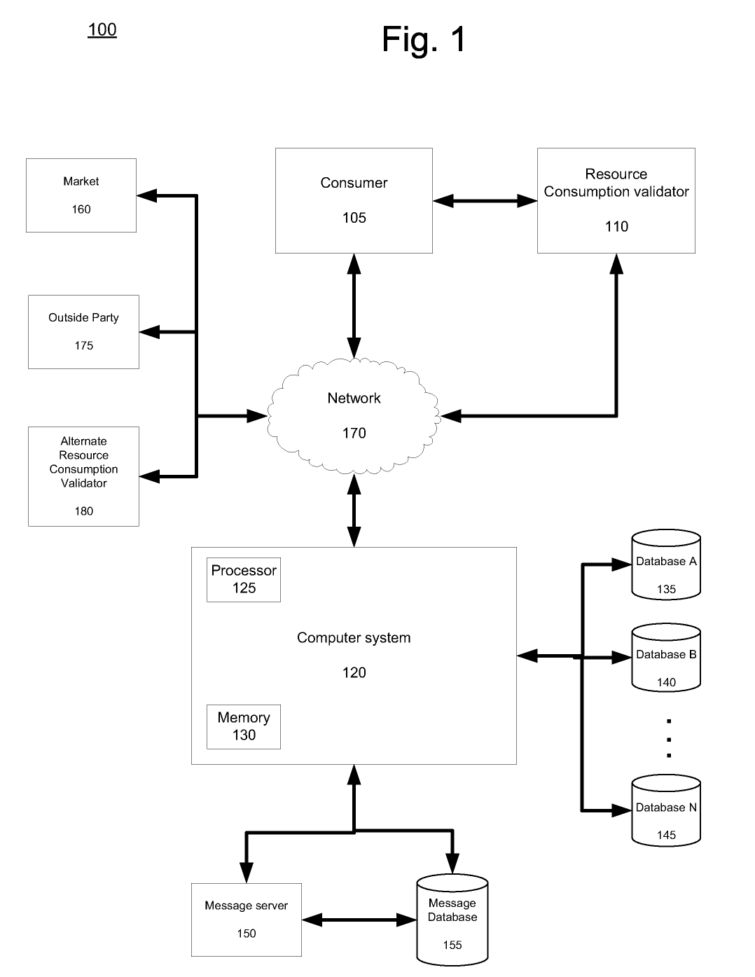

FIG. 1 is a block diagram illustrating a system 100 enabled to determine an environmental impact of a consumer's resource consumption. System 100 may include a consumer 105, a resource consumption validator 110, a computer system 120, a processor 125, a memory 130, a database A 135, a database B 140, a database N 145, a message server 150, a message database 155 and a marketplace 160.

Consumer 105 may be any consumer of any resource. Exemplary consumers include individuals, residences, businesses, and governmental agencies that consume resources. In some embodiments, consumer 105 may have a resource consumption account with a resource provider, such as a utility company or heating oil, electric power, and/or natural gas providers. Customer 105 may also have an account with a resource consumption validator. In one exemplary embodiment, consumer 105 is a motor vehicle owner and exemplary resources consumed are gasoline and/or electricity

Resource consumption validator 110 may be any provider of resources that may be consumed by the consumer and/or a validator of that consumption. Exemplary resource consumption validators are utility companies, electric power, natural gas and oil companies, gasoline stations, water providers, steel manufacturers, corn farmers, bio-fuel producers, ethanol producers, and a local, state, or federal government. A resource consumption validator may be a resource provider and/or any third party capable of validating the consumption of a consumer, such as consumer 105. Resource consumption validators 110 may utilize various resource consumption validation tools. Exemplary resource consumption validation tools include consumption meters for various resources such as electrical power or water, odometers in automobiles, sales receipts from resource providers, and purchase or sale agreements for resources. In some instances, consumers may install a resource consumption validation tool and/or opt in to a service providing resource consumption validation.

In the exemplary embodiment wherein the consumer is a motor vehicle owner, the consumer may register a motor vehicle with a resource consumption validator like resource consumption validator 110. In this case, the resource consumption validator may be a governmentally or privately run motor vehicle agency. The resource consumption validator may then validate the resource consumption of the consumer's use of the registered vehicle. Resource consumption validation may be performed by the resource consumption validator via, for example, receipt of odometer readings, or gasoline purchases, associated with the motor vehicle. Information regarding how many miles a consumer has driven in a time period, gasoline purchases for the vehicle, and/or registration information of the motor vehicle, such as make, model, and/or year, may be used to calculate how many resources, namely gasoline, electricity, or oil, the consumer consumes.

Additionally, or alternatively, resource consumption validator 110 may validate indirect resource consumption by a consumer. Exemplary indirect resource consumption may include the resources consumed during the production, transport, and/or sale of the resource consumed by the consumer. Following the example of the motor vehicle owner, exemplary resources consumed indirectly by the operation of the motor vehicle may include the resources consumed by extracting raw crude oil from a crude oil reservoir, transporting the crude oil to a refinery, refining the crude oil into gasoline or motor oil, and transporting the gasoline to a gasoline retail sale facility.

Resource consumption validator 110 may also validate any pollution or other adverse environmental effects caused directly, or indirectly, by a consumer's resource consumption. Exemplary pollution includes the emission of green house gases, like carbon dioxide, into the atmosphere, heavy metal pollution, pollution of water sources, light pollution, and sound pollution. Exemplary adverse environmental effects can include deforestation, habitat destruction, and loss of wildlife. In the example of a motor vehicle operator, adverse environmental effects may include the release of carbon dioxide into the atmosphere and habitat destruction caused by the construction of new roads on which the motor vehicle is, or may be, operated.

Computer system 120 may be any computer system capable of executing the methods of the enclosed embodiments. Computer system 120 may be a third party computer operated by an operator other than consumer 105 and resource consumption validator 110.

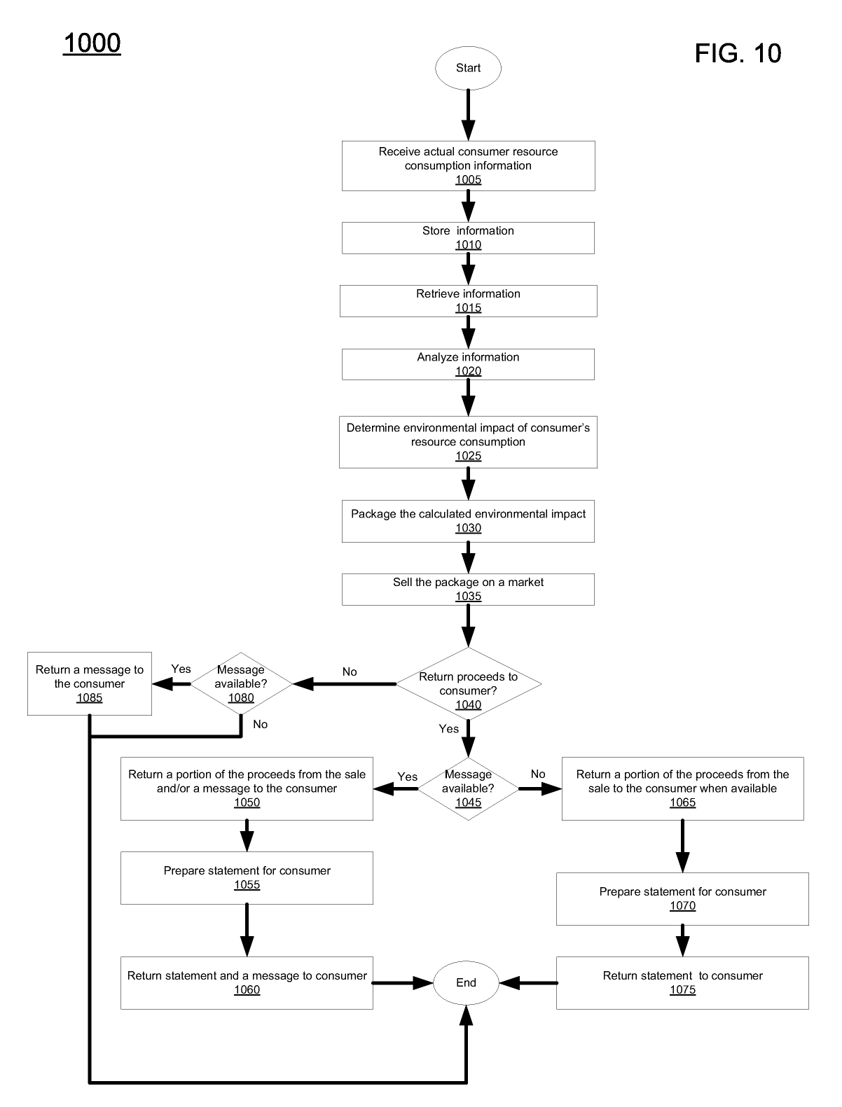

Computer system 120 may include one or more processors 125 and one or more memories 130. Computer system 120 may include a network of two or more computers. Memory 130 may be capable of storing instructions executable by a processor, such as processor 125. Computer system 120 may be enabled to execute any of processes 1000-1700, as provided with reference to FIGS. 10-17.

Processor 125 may be enabled to execute instructions to, for example, execute any of processes 1000-1700, as provided with reference to FIGS. 10-17. For example, processor 125 may be enabled to retrieve actual resource consumption information for a consumer, perform an analysis on consumption information, determine the environmental impact of the consumer's actual resource consumption, and generate statements to the consumer regarding their consumption information. Processor 125 may also be capable of parsing information and categorizing the parsed information.

Continuing the example of a motor vehicle owner, computer system 120 and/or processor 125 may be enabled to receive actual resource consumption information, such as gasoline, associated with the operation of the motor vehicle, analyze the information to produce one or more analysis results, and store the results. In some cases, computer system 120 and/or processor 125 may also determine an environmental impact based on the resources consumed by operation of the motor vehicle.

Computer system 120 may be communicatively coupled to one or more databases such as database A 135, database B 140, and database N 145. Databases 135, 140, and 145 may be enabled to store, for example, received, analyzed, categorized, and/or parsed information. The categories or types of information stored in database A 135, database B 140, and database N 145 may different from each other. For example, database A 135 may store actual electrical power consumption information, database B 140 may store actual natural gas consumption information, and database N 145 may store actual water consumption information.

Computer system 120 may be communicatively coupled to a message server 150 and/or message database 155. Exemplary messages served by message server 150 include advertisements, recommendations, reminders, requests for more information or payment, public service announcements, and the like. Message server 150 may be capable of serving messages to a consumer, such as consumer 105. Messages to be served to the consumer may be retrieved from a message database, such as message database 155. Messages may be supplied to message database 155 by, for example, message server 150 (which, in an embodiment, could be an ad server), an advertising entity (not shown), or a messaging entity (not shown). In some embodiments, database A 135, B 140, and/or N 145 may receive a message from computer system 120.

In the example of a motor vehicle operator, a message relating to methods or products available to decrease the consumer's consumption of gasoline may be, for example, retrieved from message database 155 and served to the consumer via message server 150.

Market 160 may be any market in which an environmental impact may be sold. Exemplary markets 160 include a commodities exchange, a retail market, or a private market where a package is sold via, for example, a bilateral contract. For an exemplary motor vehicle operator, the environmental impact of the motor vehicle's operation or carbon dioxide produced by its use may be packaged and sold on market 160.

Network 170 may be any network capable of facilitating communication between consumer 105 and/or resource consumption validator 110 with computer system 120. Exemplary networks 170 can include the Internet and a wireless local area network (WLAN).

In one embodiment, system 100 may include an outside party 175. Outside party 175 may be any party or entity in communication with computer system 120 via, for example, network 170. Outside party 175 may be a developer, maintainer, and/or facilitator of computer software and/or feature sets related to, for example, resource consumption. In most cases, outside party 175 will not be consumer 105 or consumption validator 110. Exemplary outside parties 175 can include governmental agencies, environmental conservation groups, and entities related to resource consumption conservation and/or management. Exemplary software programs include alternative resource consumption management accounts and may be available online via, for example, a web site, or via a widget or software application downloadable to a mobile device like a mobile phone.

Outside party 175 may receive actual resource consumption information associated with a consumer and, on some occasions, use this received information to develop, maintain, and/or manage computer software and/or feature sets provide to, for example, a consumer.

In another embodiment, system 100 may include an alternate resource consumption validator 180. Alternate resource consumption validator 180 may be any entity capable of providing a consumable resource and/or validating resource consumption via, for example, a resource consumption measurement tool. Alternate resource consumption validator 180 may be provided to a consumer as an alternative to resource consumption validator 105.

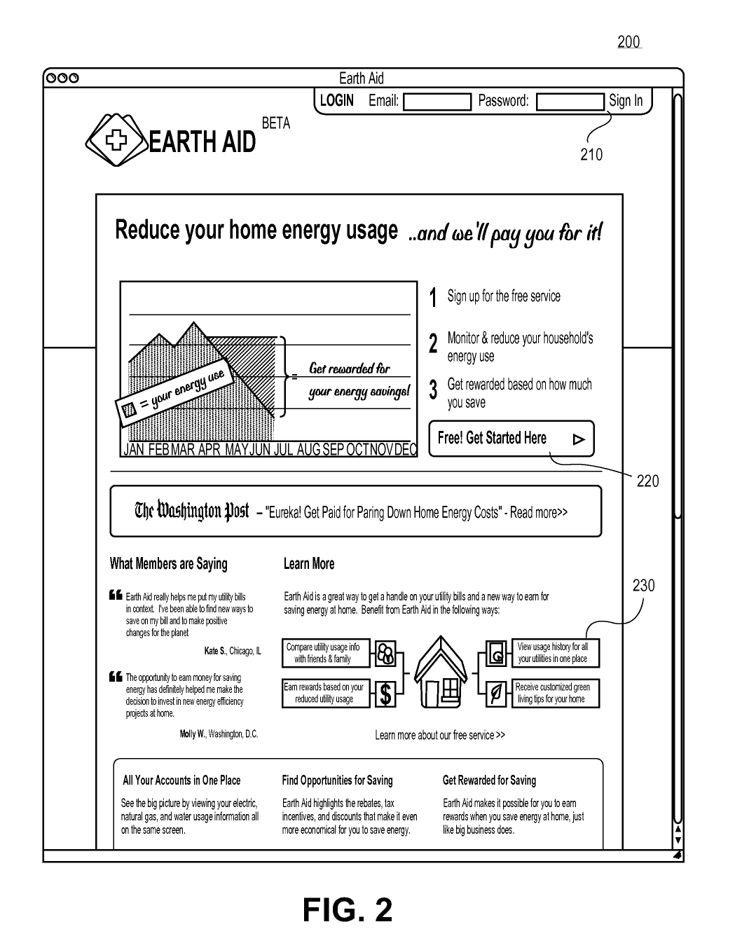

FIGS. 2-9 are exemplary screen shots that may be provided to a consumer via, for example, a web site, a widget, and/or a software application suitable for a mobile device, like a mobile phone.

FIG. 2 is a screenshot of an exemplary GUI 200 illustrating an access portal for entering an online resource consumption management account for a consumer's resource consumption. GUI 200 includes a login menu 210. Login menu 210 provides textboxes in which a consumer may enter login information, such as a user ID and a password. Entry of correct login information into the textboxes provided in menu 210 may enable the consumer to access an online resource management account, a dashboard affiliated with an online resource management account, and/or a resource consumption account.

GUI 200 may also include a button 220 that, when selected by a consumer, may enable the consumer to register, or sign-up, with the online resource consumption management account. GUI 200 may also include one or more windows 230 including, for example, information related to resource consumption, news, tips for reducing resource consumption, a reward earning opportunity, and an advertisement.

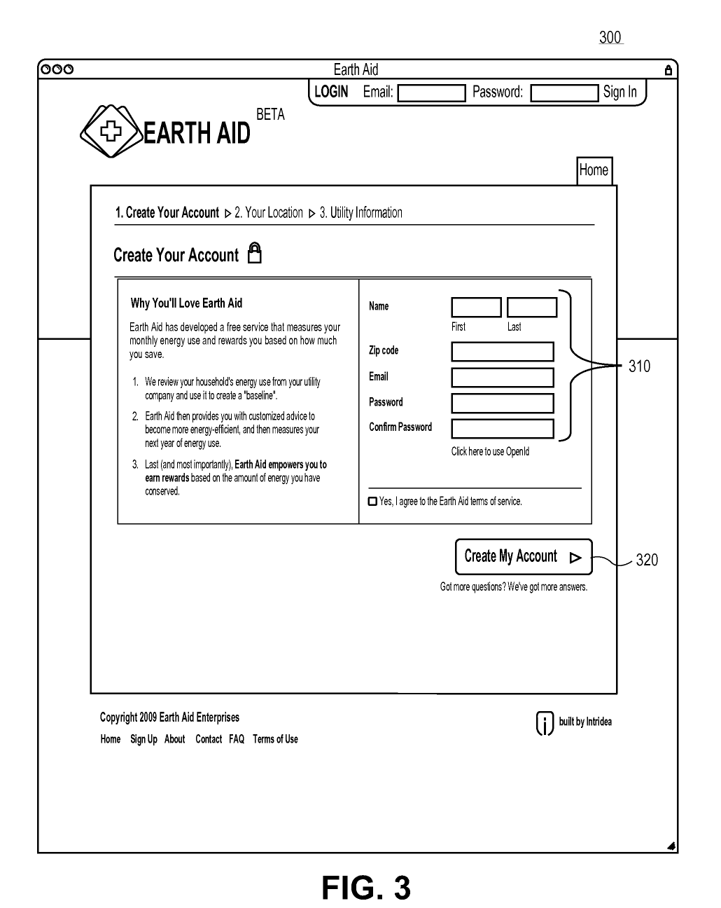

FIG. 3 is a screenshot of an exemplary GUI 300 for creating an online resource consumption management account. GUI 300 provides one or more textboxes 310 for the entry of consumer registration information, such as a consumer's name, password, and/or user ID. GUI 300 also includes a button 320 that, when selected, enables a consumer to create online resource consumption management account using the entered information.

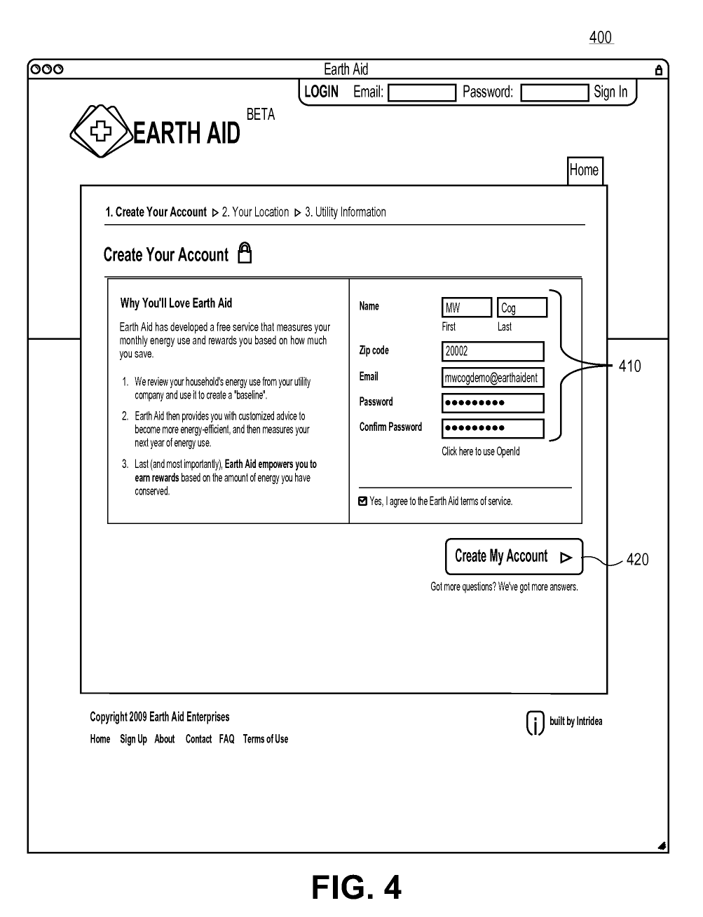

FIG. 4 is a screenshot of an exemplary GUI 400 enabling a consumer to enter location information relating to one or more resource consumption accounts the consumer is enrolled in, subscribes to, or otherwise participates in. Exemplary resource consumption accounts may be with an electricity, natural gas, propane, and water provider or resource consumption validator. GUI 400 includes one or more textboxes 410 that enable the consumer to enter location information associated with one or more resource consumption accounts and a button 420 that, when selected by the consumer, enable the consumer to save entered location information and continue with the registration process.

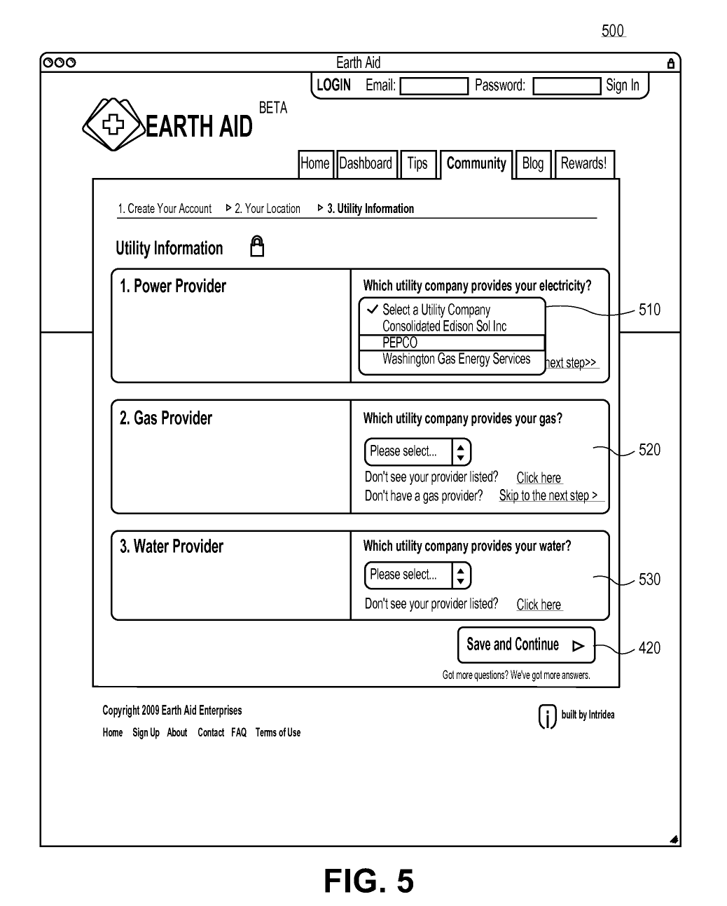

FIG. 5 is a screenshot of an exemplary GUI 500 that enables a consumer to enter information regarding one or more resource consumption accounts with a resource consumption validator, such as an electricity or water utility company associated with the consumer. GUI 500 includes one or more dropdown menus 510 that include a list of resource consumption validators. The list of resource consumption validators may be adapted to be appropriate for the location entered by the consumer via GUI 400, or to any other criteria, such as a geo-location determined from a consumer's IP address. For example, dropdown menu 510 may include a list of utilities servicing a particular geographic territory. The consumer may select one or more resource consumption validators to associate with the online resource consumption management account from dropdown list 510.

GUI 500 may also include one or more textboxes and/or dropdown menus 520 and 530 that enable a consumer to provide registration information regarding the resource consumption account associated with the resource consumption validator the consumer selected via dropdown list 510. GUI 500 may also include selectable button 420.

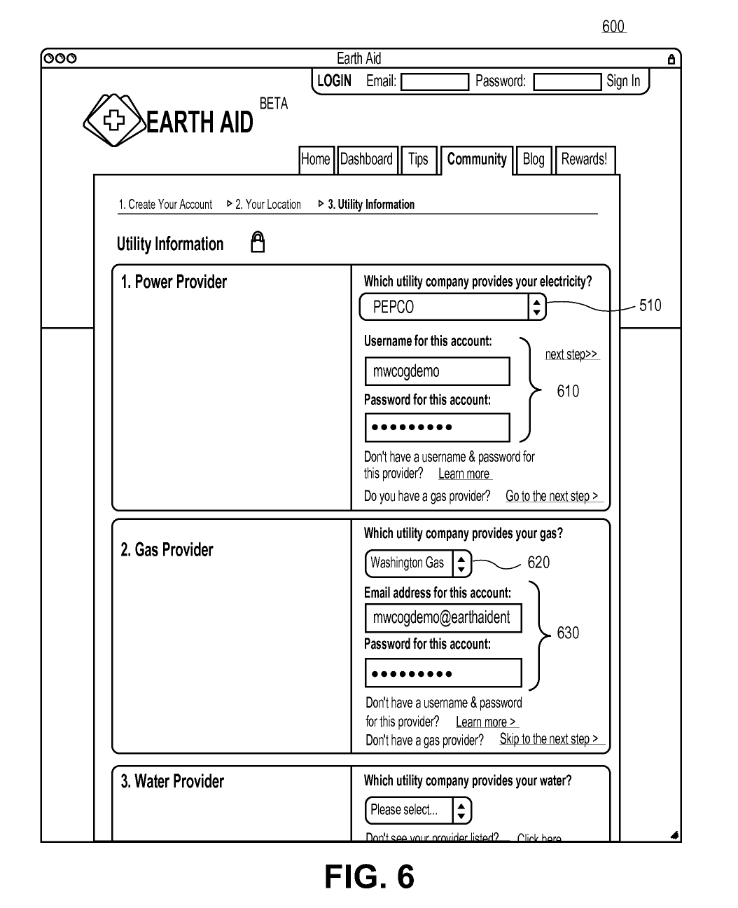

FIG. 6 includes an exemplary GUI 600 that provides a consumer with a selectable dropdown menus 510 and 620 from which the consumer may select a resource consumption validator, such as resource consumption validator 110. GUI 600 may also provide one or more textboxes 610 and 630 enabling a consumer to enter consumer registration information such as a username and/or a password that are linked to the consumer's resource consumption account with the resource consumption validator.

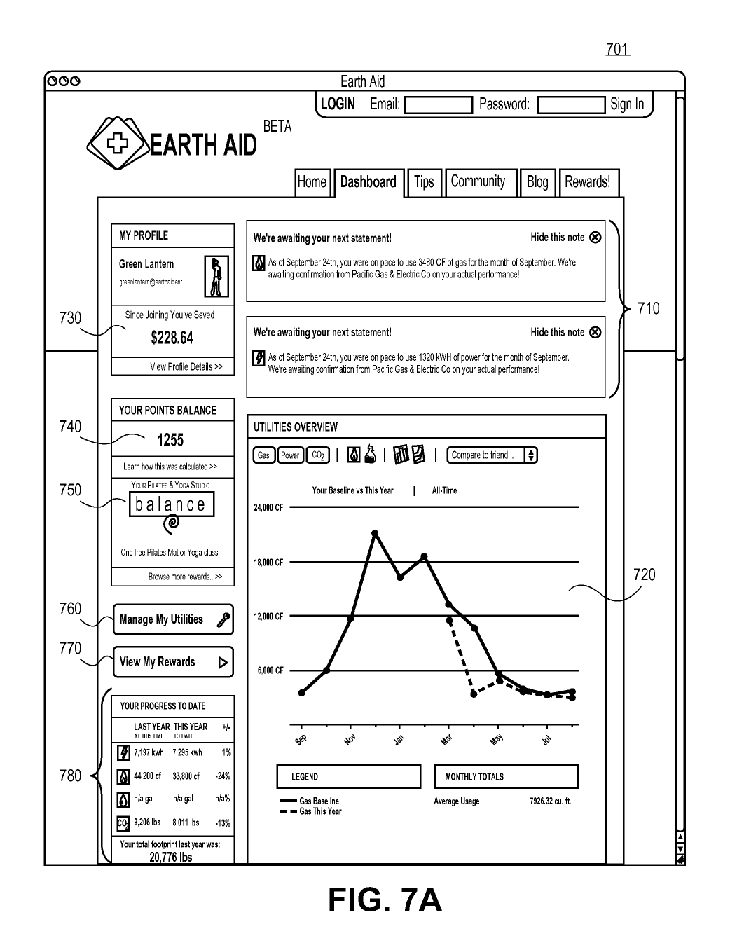

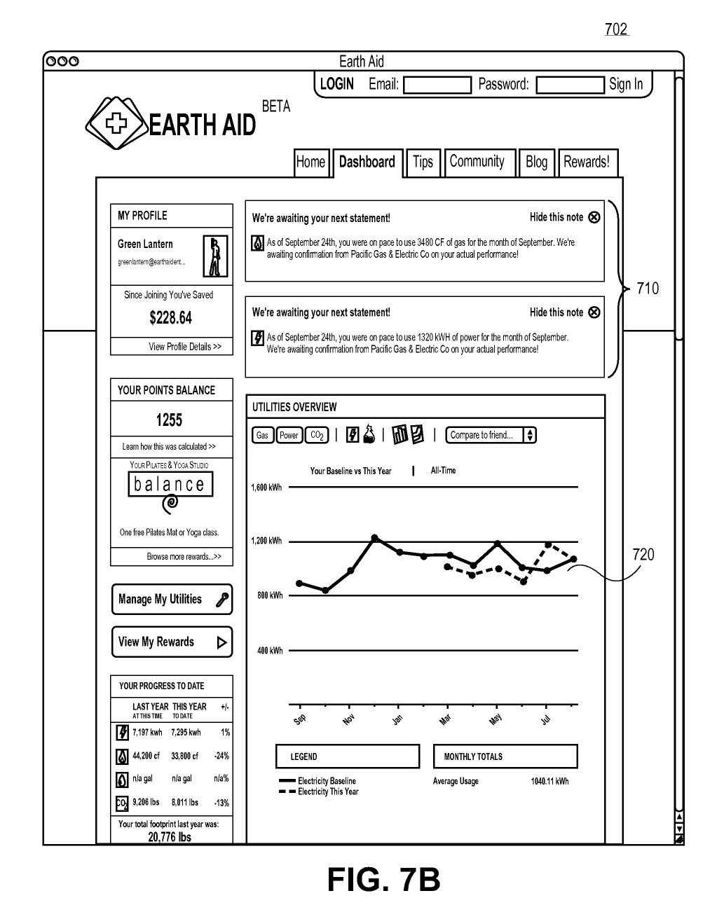

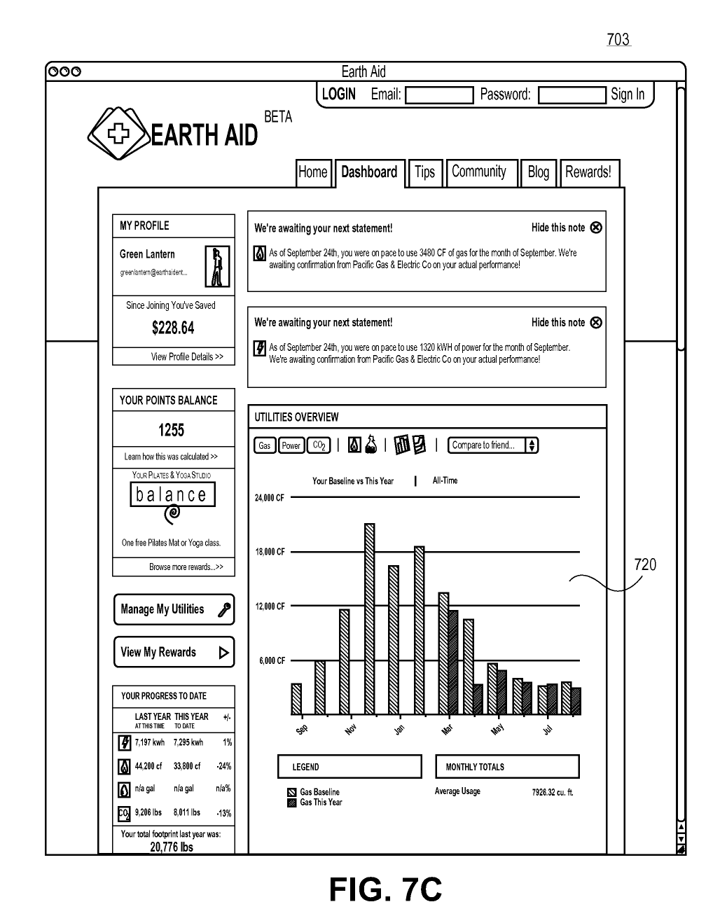

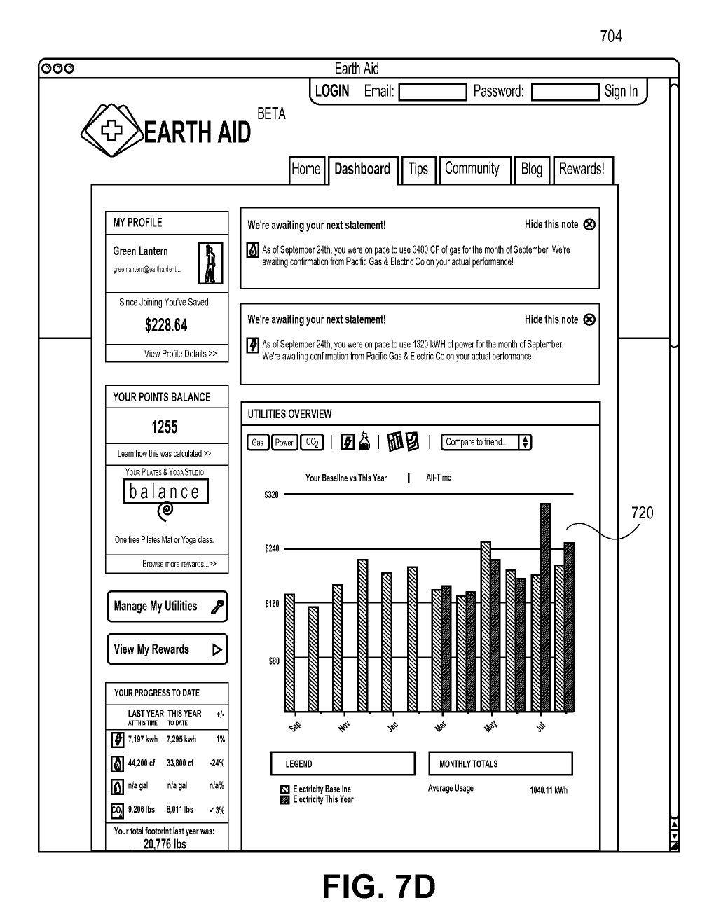

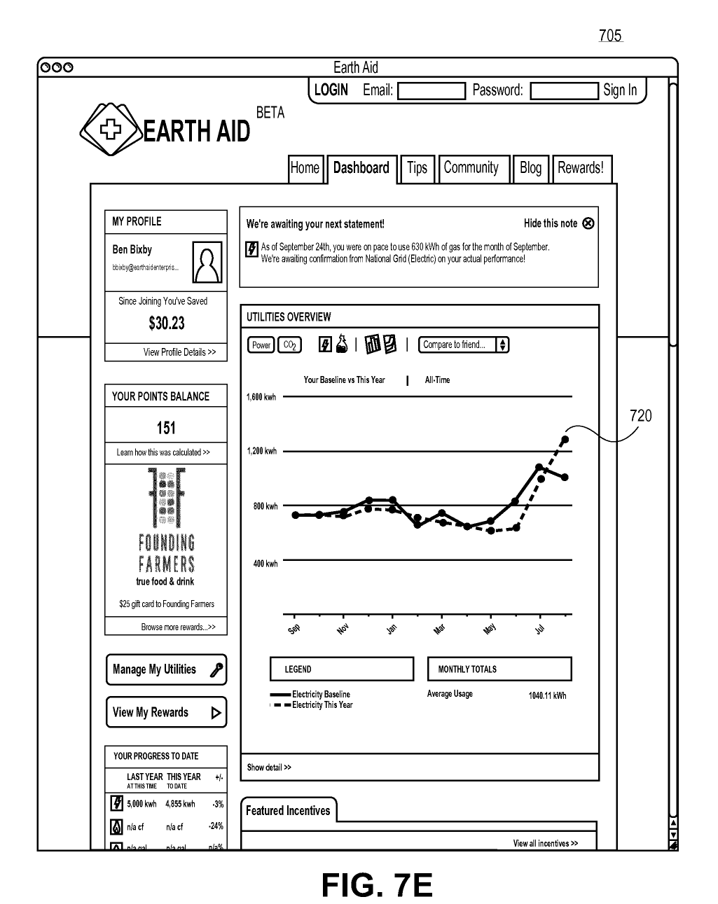

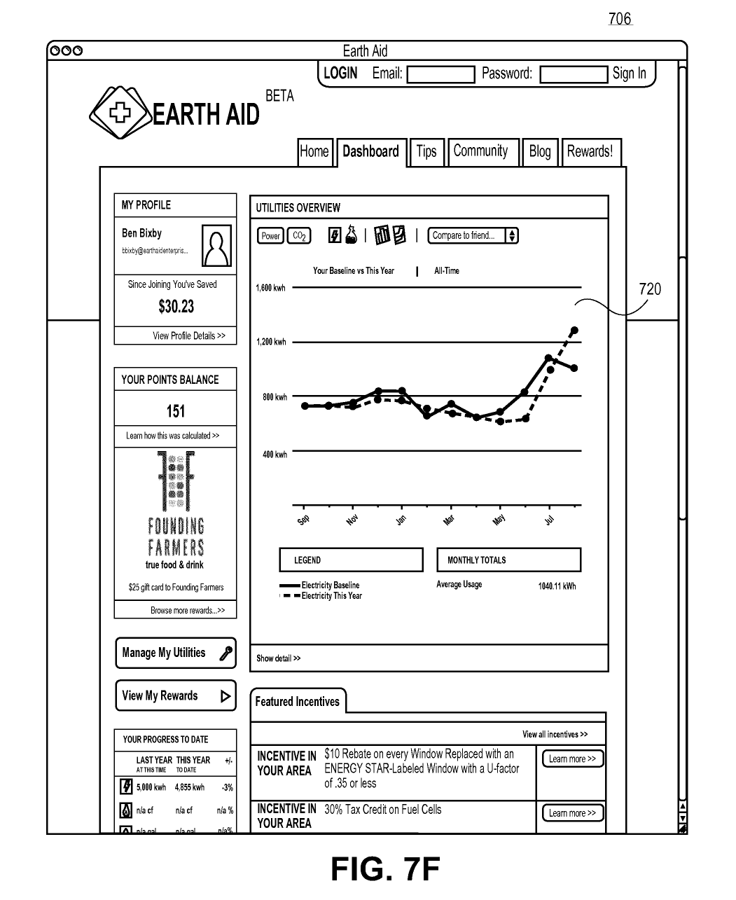

FIGS. 7A-7F are screenshots of exemplary GUIs 701-706 that provide various statements to a consumer regarding the online resource consumption management account. For example, GUI 701 includes status information box 710. Status information box 710 may include, for example, information regarding the status of the online resource consumption management account and the information that has been gathered regarding the consumer's resource consumption.

GUI 701 may include one or more graphs or tables 720 that illustrate the historical resource consumption of the consumer. GUI 701 may also include a financial account box 730 that may display a calculated monetary savings or credit earned related to the online resource consumption management account. For example, financial account box 730 may display an amount of financial savings accrued or credit earned via conservation of resource consumption. GUI 701 may also include, a reward point balance box 740 and/or a window 750, that may include an advertisement or award that may be available using, for example, one or more reward points and/or financial savings displayed in financial account box 730 and/or reward point balance box 740.

In some cases GUI 701 may include a link that when selected enables a consumer to manage and/or directly access one or more resource consumption accounts associated with the online resource consumption management account.

In some cases GUI 701 may include a progress information pane 780 for displaying progress the consumer has made in conserving resource consumption. Exemplary information included in progress information pane 780 includes an amount of pollutants or toxins like carbon dioxide or pounds of carbon that have not been emitted into the atmosphere and/or the environment as well as other direct and/or indirect environmental impacts resultant from a consumer's resource consumption.

FIG. 7B is a screenshot of an exemplary GUI 702 that includes a graph depicting a consumer's resource consumption over time 720.

FIG. 7C is a screenshot of an exemplary GUI 703 that depicts an exemplary bar graph of a consumer's resource consumption of natural gas over time 720.

FIG. 7D is a screenshot of an exemplary GUI 704 depicting an exemplary bar graph of a consumer's resource consumption over time 720. In this case, the resource consumed is electrical power.

FIG. 7E is a screenshot of an exemplary GUI 705 depicting a line graph 720 of a consumer's historical electrical power consumption 720.

FIG. 7F is a screenshot of an exemplary GUI 706 depicting a line graph 720 of a consumer's historical electrical power consumption 720.

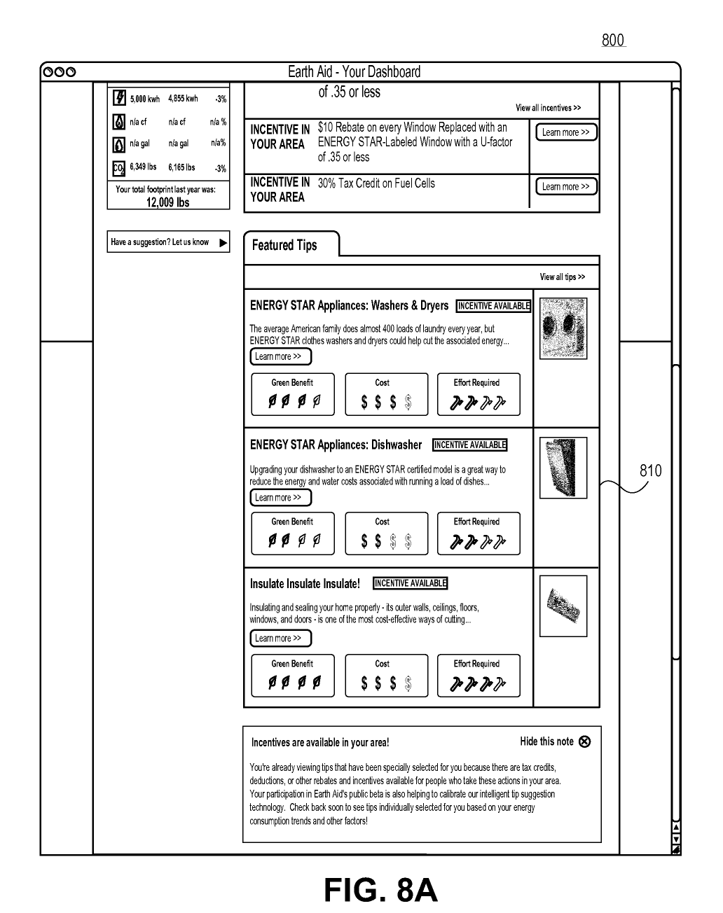

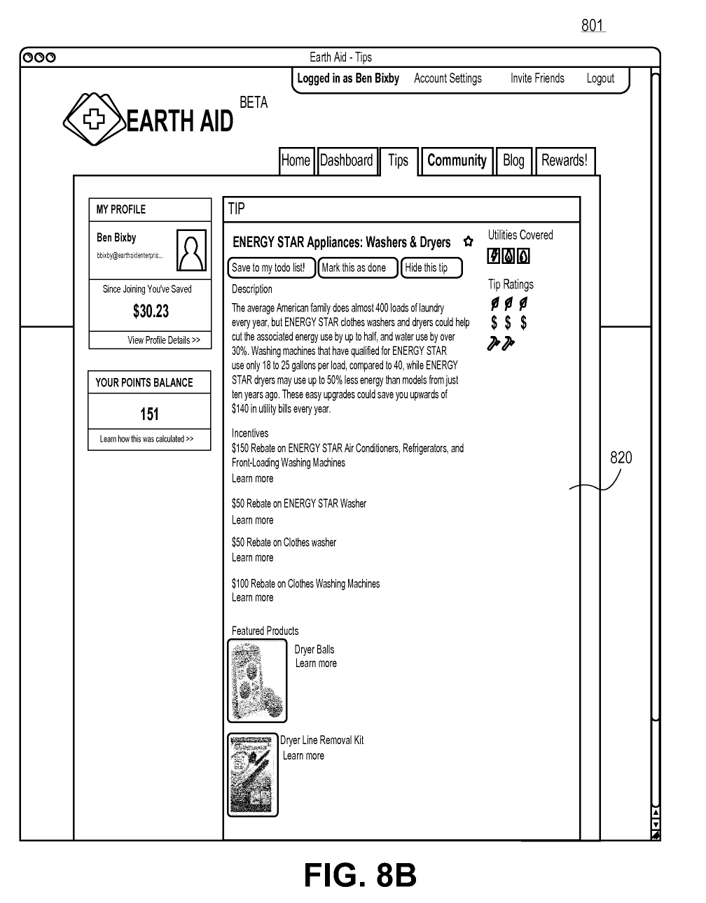

FIG. 8A is a screenshot of an exemplary GUI 800 depicting one or more messages 810 provided to a consumer. Message 810 provided to the consumer in GUI 800 may concern advice relating to resource conservation. For example, message 810 displays various ENERGY STAR® appliances the consumer may purchase and install, the use of which may lead to resource consumption conservation. Message 810 may include one or more selectable links, that when selected enable the display of additional information related to message 810.

FIG. 8B is a screenshot of an exemplary GUI 801 that shows one or more messages 820 displayed following selection of a link provided in message 810.

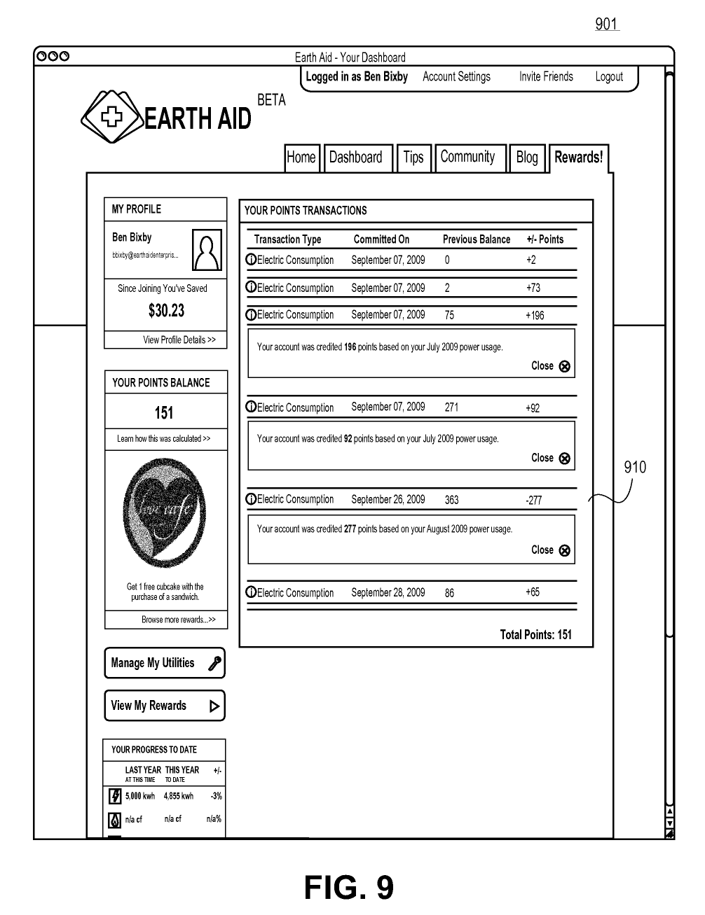

FIG. 9 is a screenshot of an exemplary GUI 901 including a statement 910 of a consumer's actual resource consumption and may include a statement of points accrual related to a change in a consumer's actual resource consumption. Statement 910 may include various statistics relating to a consumer's actual, current, and/or historical resource consumption.

FIG. 10 is a flow diagram illustrating a process 1000 for determining an environmental impact of a consumer's actual resource consumption. A determined environmental impact may be aggregated, packaged, and/or sold via process 1000. Process 1000 may be executed by any system capable of determining an environmental impact of a consumer's resource consumption, packaging a determined environmental impact, and/or selling a packaged environmental impact, such as system 100.

In step 1005, actual resource consumption information for a consumer, such as consumer 105 may be received. The actual resource consumption information may be received from, for example, a resource consumption validator, such as resource consumption validator 110. In one embodiment, the actual resource consumption information may be fetched from a resource consumption validator. In some cases, the actual resource consumption information may be verified by, for example, a resource consumption validator, such as resource consumption validator 110.

In step 1010, the received information may be stored in, for example, a memory, such as memory 130 and/or a database, such as databases 135-145. In step 1015, the stored information may be retrieved from its storage location. In step 1020, the retrieved information may be analyzed. This analysis may include determining the frequency with which the resource consumption validator reports new actual consumer resource consumption information. Analysis may also include summarizing, categorizing, normalizing, parsing, and/or otherwise manipulating the information. The parsing may include identifying relevant information within the received information. In some cases, a consumer and/or administrator of process 1000 may determine relevant information. Exemplary relevant information includes identifying information for the consumer, the quantity of a resource consumed, and the price of the resource. Once analyzed, the information may be stored in, for example, a memory, such as memory 130 and/or a database, such as databases 135-145.

In step 1025, an environmental impact of the consumer's resource consumption may be determined. This determination may be made using any acceptable means for determining an environmental impact of a resource's consumption. Exemplary types of determinations include calculating the amount of carbon dioxide produced by the resource consumption, and calculating the amount of water or other natural resources used by the resource consumption.

Such determinations may further be based on information about the amount of energy required to produce the resource in a given geographic location. For example, in a geographic location where the burning of coal produces electricity, the amount of carbon dioxide produced by such burning per unit of electricity consumed can be determined.

In step 1030, the calculated environmental impact may be packaged. Packaging may include aggregating the environmental impact from two or more consumers. Environmental impacts may be aggregated according to one or more criteria. Exemplary criteria for packaging and/or aggregating may include type of resource consumer, demographic information of the consumer, type of resource, and amount of consumption. Exemplary packaging includes a generation of a carbon credit(s) or resource consumption right(s), such as water, mining, and land rights. In 1035, the package may be sold on a market, such as a commodity exchange or through a private market via, for example, a bilateral contract. In some cases, a consumer may deliberately set aside, or retire, a packaged environmental impact so that it may not be sold or exchanged. A consumer may deliberately retire a packaged environmental impact so that another entity will not be able use the packaged environmental impact to accrue any rights, such as pollution rights, land rights, and/or water rights. In step 1040, it may be determined whether to return a portion of the proceeds from the sale of the environmental impact to the consumer or a designate of the consumer, for example, a charity or public service organization.

In step 1045, it may be determined whether there is a message available to be delivered to, for example, the consumer. Such messages may include, for example, advertisements, advice, recommendations, and/or reminders. The messages may be from any source, such as a message server like message server 150, a message database like message database 155, and/or a printed material included in a paper statement. The message may be targeted to the consumer according to, for example, demographic information associated with the consumer or the type of resource consumed by a consumer. On some occasions, the message may be from a purchaser of the consumer's determined environmental impact. In this case, the purchaser's name may appear on a check or other financial instrument issued to the consumer for the proceeds and/or the purchaser may include advertising messages along with the returned proceeds. Exemplary purchasers may include purchasers of carbon credits on a carbon market or purchasers of an environmental impact operating under a regulatory scheme or cap and trade scheme. When a message is available a portion of the proceeds from the sale and/or a message may be returned to the consumer (step 1050).

In step 1055, a statement may be prepared for the consumer. A statement may include information regarding a consumer's resource consumption such as the quantity of their current and/or historical actual resource consumption, possible ways to conserve consumption of resources, comparisons between the consumer's consumption of resources and the resource consumption of other consumers. The statement may also include the environmental impact of a consumer's resource consumption, the value of that impact on a market, and an amount to be returned to the consumer as a result of a sale of the environmental impact of their resource consumption.

In step 1060, the statement and a message may be returned to the consumer and process 1000 may end. Step 1060 may be executed via, for example, an email, a web site, or a paper statement mailed through, for example, the United States Postal Service. The message may be the same as, or different from, the message returned in step 1050.

If a message is not available, a portion of the proceeds from the sale of the packaged environmental impact may be returned to the consumer (step 1065). A statement similar to the statement prepared in step 1055 without a message may be prepared for the consumer (step 1070) and may then be returned to the consumer (step 1075) and process 1000 may end.

In step 1080, it may be determined whether there is a message available to be delivered to, for example, the consumer. Step 1080 may resemble step 1045. Such messages may include, for example, advertisements, advice, recommendations, and/or reminders. The messages may be from any source, such as a message server like message server 150, a message database like message database 155, and/or a printed material included in a paper statement. The message may be targeted to the consumer according to, for example, demographic information associated with the consumer or the type of resource consumed by a consumer. When a message is available, it may be returned to the consumer (step 1085). When a message is not available, process 1000 may end.

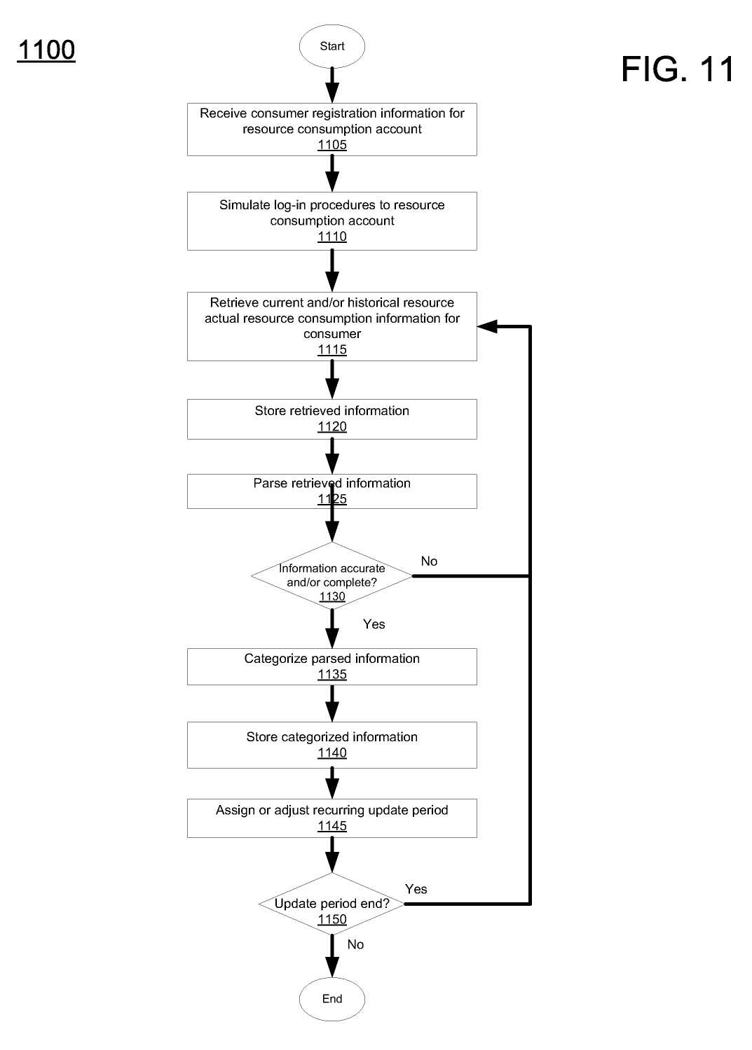

FIG. 11 is a flow diagram illustrating a process 1100 for retrieving, parsing, and/or categorizing current and/or historical actual resource consumption information. Process 1100 may be executed by any system capable of retrieving, parsing, and/or categorizing current and/or historical actual resource consumption information, such as system 100.

In step 1105, consumer registration information may be received for a resource consumption account. A resource consumption account may be related to any type of resource such as fuel, oil, electricity, natural gas, water, or construction materials. A resource consumption account may be with, for example, a resource consumption validator, a utility company such as an electric, natural gas, and/or water provider, or a natural resource provider such as a farmer or lumber provider. The consumer registration information may be received via, for example, a consumer through an opt-in procedure executed via a web site, mail, or telephone or may be received from, for example, a resource consumption validator, such as resource consumption validator 110.

In step 1110, an access or login procedure may be performed or simulated in order to open and retrieve information from the resource consumption account. Accessing or logging into an account may be done via, for example, a computer system, such as computer system 120 or a consumption validator such as resource consumption validator 110. Once the consumer's account is accessed, current and/or historical actual resource consumption information may be retrieved from, for example, the resource consumption validator, in a step 1115. In an alternative embodiment not shown in FIG. 11, actual resource consumption information may be received directly from a resource consumption validator. For example, a resource consumption validator may have the capability to supply actual resource consumption information to a system according to the present invention.

In step 1120, the retrieved information may be stored in, for example, a database, such as databases 135-145 and/or a memory, such as memory 130. The retrieved information may then be parsed in step 1125. In one embodiment, a resource consumption validator, such as resource consumption validator 110, may post resource consumption information for a consumer on a web site. In this embodiment, parsing may include, for example, retrieving information from the Web site, such as code, which, in some cases, may be hypertext markup language (HTML) code. Parsing may further include analyzing the retrieved data to isolate relevant data. The relevance of data may be established by, for example, an administrator of process 1100, or a consumer, such as consumer 105. Relevant data may include, for example, the consumer's name, address, resource consumption account number with the resource consumption validator, and/or actual resource consumption information.

One way to isolate relevant data in retrieved data may be to sequentially analyze the retrieved code, from beginning to end, to remove irrelevant data, such as web site formatting data, until relevant data is found. Once found, the relevant data may be recorded and stored on, for example, a memory, such as memory 130, or a database, such as databases 135-145. This process may continue until all of the relevant information is isolated and/or there is no more code to analyze.

In step 1130, it may be determined whether the parsed information is accurate and/or complete. This determination may include, for example, verifying that the consumer matches the account that was accessed and/or determining whether the information is complete. If the information is not accurate or complete, then steps 1115 through 1120 may be repeated.

When the information is accurate and/or complete, the parsed information may be categorized into one or more categories (step 1135). Exemplary categories include: type of resource consumed, time period of the consumption, type of consumer, demographic information related to the consumer, and geo-location of the consumer and/or resource.

In step 1140, the categorized information may be stored in, for example, a database, such as databases 135-145 and/or a memory, such as memory 130. In step 1145, a reoccurring update period may be assigned to or adjusted for the consumer account. The reoccurring update period may be assigned or updated based on, for example, the frequency that a resource consumption validator provides information regarding the consumer's actual consumption of resources. For example, a reoccurring update period may be assigned so that information is retrieved on a monthly, weekly, daily, or real-time basis according to how often the resource consumption validator posts actual consumption information to an account.

In step 1150, it may be determined whether the update period has ended or expired. If the update period has ended, steps 1115 through 1145 can be repeated. If the update period has not ended then process 1100 may end.

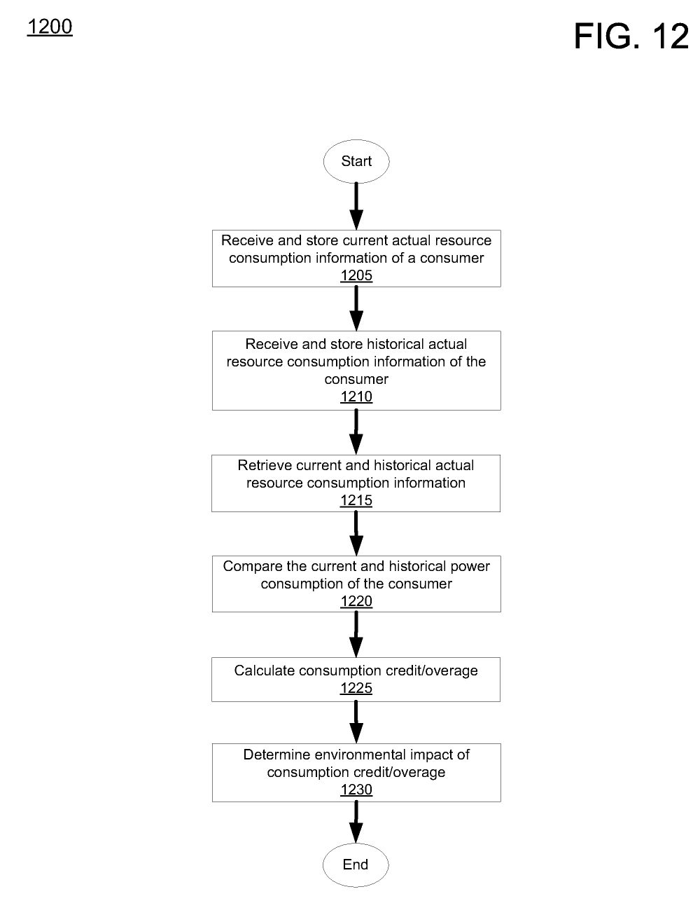

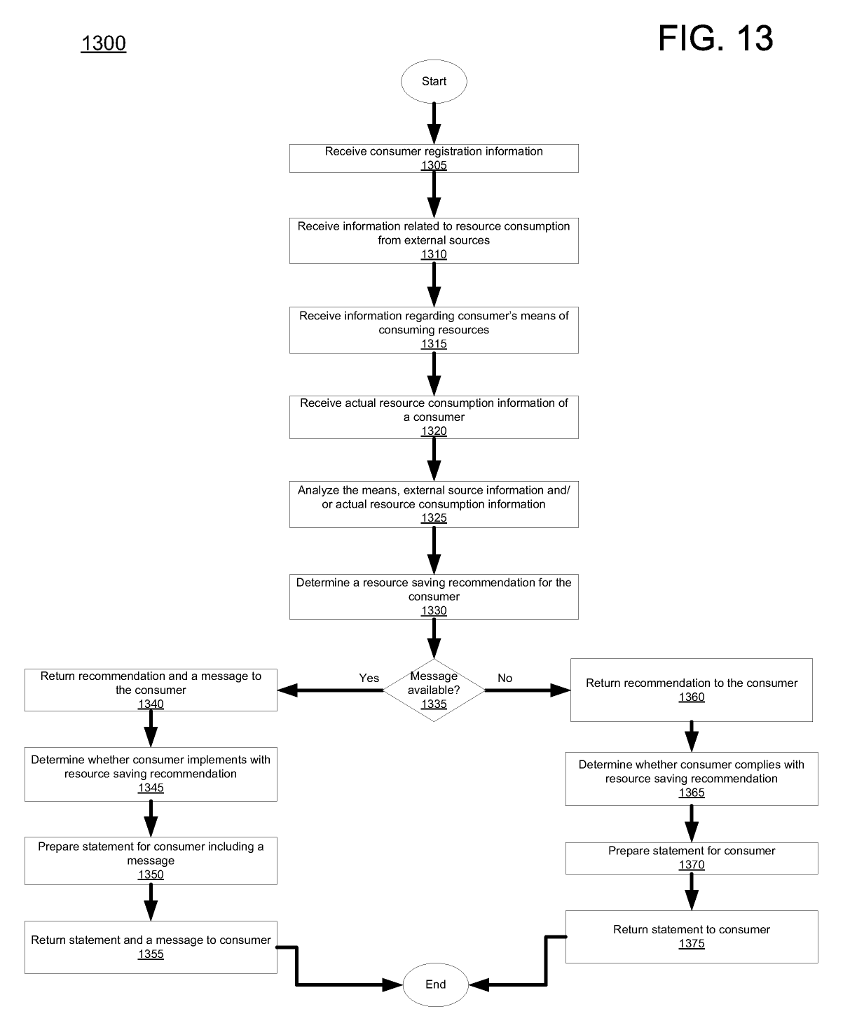

FIG. 12 is a flow diagram illustrating a process 1200 for determining an environmental impact of a consumer's actual resource consumption. According to another embodiment of the invention, process 1200 may be executed by any system capable of determining an environmental impact of a consumer's actual resource consumption, such as system 100.

In step 1205, actual resource consumption information of a consumer, such as consumer 105, may be received and stored. The information may be received by, for example, a computer system like computer system 120 and may be stored in a database, like databases 135-145, or a memory, like memory 130.

In step 1210, historical actual resource consumption information of the consumer may be received and stored. The information may be received by, for example, a computer system like computer system 120 and may be stored in a database, like databases 135-145, or a memory, like memory 130.

In step 1215 the stored current and/or historical actual resource consumption information may be retrieved from, for example, the database or memory. In step 1220, the current and/or historical actual resource consumption information of the consumer may be analyzed. This analysis may include comparing the historical information to the current information and/or the historical information from one time period or periods to the historical information of another time period or periods. In step 1225, the results of the comparison, or the resource consumption credit or overage of the current actual resource consumption when compared to the historical actual resource consumption may be calculated.

In step 1230, the environmental impact of the resource consumption credit or overage may be determined This determination may be similar to the determination of step 225 as shown in FIG. 10 and process 1200 may end.

FIG. 13 is a flow diagram illustrating a process 1300 for determining a resource saving recommendation for a consumer, and/or delivering a statement to the consumer. Process 1300 may be executed by any system capable of determining a resource saving recommendation for a consumer, and/or delivering a statement to the consumer, such as system 100.

In step 1305, consumer registration information may be received. The registration information may include, for example, consumer-identifying information, consumption validation identifying information, the type of resource consumed, products the consumer uses that consume resources, a habit or behavioral pattern associated with a consumer's resource consumption, and the geo-location of the consumption. Consumer registration information may be received via, for example, a web site, an email, or written correspondence.

In step 1310, information related to resource consumption may be received from one or more external sources that have such information available. Exemplary external sources include a resource consumption validator such as resource consumption validator 110, a municipality, local, state, or national government, a government agency such as the Environmental Protection Agency, the National Weather Service, a taxing authority, a third-party database maintained by, for example, LexisNexis, or a board of health. Other exemplary external sources are resource consuming appliance manufacturers such as motor vehicle or household appliance manufacturers.

In step 1315, information regarding the consumer's means of consuming resources may be received. This information may include the type of resource consuming appliances the consumer uses such as, for example, their type or brand of refrigerator or hot water heater. This information may be received in response to one or more questions presented to a consumer and may be received during, for example, a customer registration process or subsequent communication session.

In step 1320, the actual resource consumption information of a consumer, such as consumer 105, may be received. In step 1325, the information from external sources and/or actual resource consumption information may be analyzed alone or in combination with one another. This analysis may include parsing and/or categorizing the information.

In step 1330, a resource saving recommendation for the consumer may be determined. This determination may or may not be related to any of the received and/or analyzed information. The recommendation may be directed to, for example, a public service announcement, or ways that the consumer can conserve resources or save money. In one example, information regarding the make and year of a refrigerator used by a consumer is received from, for example, a consumer or a sales record. The resource consumption efficiency of the refrigerator as well as other specifications related to the refrigerator may be analyzed together to determine possible cost and resource saving measures that can be undertaken by a consumer, such as consumer 105, to conserve resource consumption. Recommendations may include, replacing a current refrigerator, changing a component of the existing refrigerator, or adjusting the temperature of the refrigerator. An estimated amount of resource consumption conservation for each of these recommendations may also be provided to the consumer. Advice may also be offered to the consumer so that they may decide on the recommendation that works best for him or her. Advice may accompany the recommendation or may be accessed through, for example, interfacing with a customer service representative via, for example, email, telephone or SMS text message. The consumer may also access advice directly, without interfacing with a customer service representative. This access may be implemented by, for example, the consumer accessing other information provided along with the recommendation, such as a web site, blog, or printed materials. On some occasions, the consumer may access the advice via an electronic messaging mechanism, such as via an email or SMS text message.

In step 1335, it may be determined whether a message is available to the consumer based on, for example, the recommendation. The message may be similar to the message of step 1045 as described with reference to FIG. 10. In some cases, the message may be related to the recommendation such that, using the example above, a recommendation to get a new refrigerator may be returned with an advertisement for refrigerator sales or repair.

When a message is available, a recommendation and a message may be returned to the consumer (step 1340). In step 1345, it may be determined whether the consumer implemented the resource saving recommendation. This determination may be made through comparing historical and current actual resource consumption information and determining whether there is a change in the consumer's resource consumption. In some cases, this determination may incorporate other factors such as weather conditions or seasonal resource consumption needs. In some instances, the determination of step 1345 may be made through asking the consumer whether or not they implemented the recommendation.

In step 1350, a statement including a message may be prepared for the consumer. The statement may include information regarding the consumer's resource consumption, possible ways to conserve resources, or cost savings attributable to implementing the resource saving recommendation. The statement prepared in step 1350 may be similar to the statement prepared in step 1055 as discussed with reference to FIG. 10. In step 1355, the statement and the message may be returned to the consumer via, for example, an email message, a SMS text message, a web site, or a paper statement delivered through the United States Postal Service and process 1300 may end.

When a message is not available, a recommendation without a message may be returned to the consumer (step 1360). In step 1365, it may be determined whether the consumer is complying with the resource recommendation. This step may be similar to step 1345. A statement may then be prepared for the consumer (step 1370) and returned to the consumer (step 1375) and process 1300 may end. Steps 1370 and 1375 may be similar to steps 1350 and 1355.

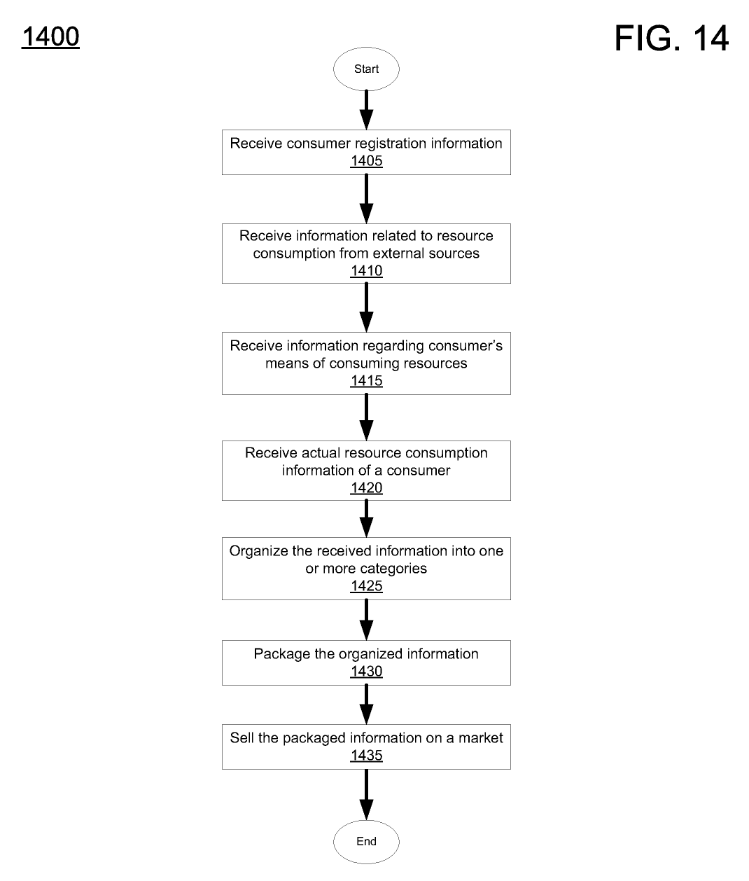

FIG. 14 is a flow diagram illustrating a process for packaging and/or selling information related to the resource consumption of a consumer. Process 1400 may be executed by any system capable of packaging and/or selling information related to the actual resource consumption of a consumer, such as system 100.

In step 1405, consumer registration information may be received. The registration information may include consumer identifying information, consumption validation identifying information, the type of resource consumed, and the geo-location of the consumption. Consumer registration information may be received via, for example, a web interface such as a web site, an email, or written correspondence.

In step 1410, information related to resource consumption from external sources may be received. Step 1410 may be similar to step 1310 as discussed with reference to FIG. 13. In step 1415, the received information regarding the consumer's means of consuming resources may be received. Step 1415 may be similar to step 1315 as discussed with reference to FIG. 13.

In step 1420, actual resource consumption information for a consumer may be received according to the processes described in, for example, FIGS. 10 and 11. In step 1425, the received information may be organized into a category. Exemplary categories include demographic categories such as age or gender, the geographic location of the consumer, the means of consuming resources, etc. In some embodiments, information may be organized according to the type of cars, appliances, or products that are owned or used by a consumer.

In step 1430, the information may be packaged. This packaging may include aggregating the information of two or more consumers and/or aggregating information from two or more consumers organized into in one or more of the categories. Exemplary packaging includes mailing lists or demographic data. In step 1435, the packaged information may be sold in a market. Exemplary markets include advertising markets or commodity exchanges.

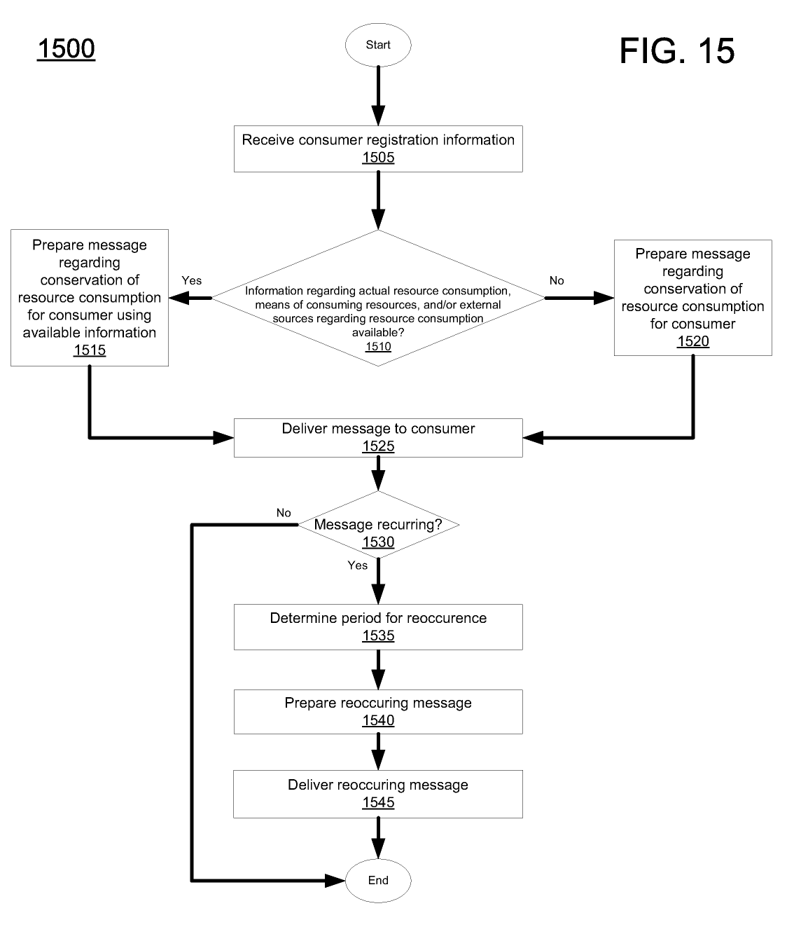

FIG. 15 is a flow diagram illustrating a process 1500 for delivering a message to a consumer. Process 1500 may be executed by any system capable of delivering a message to a consumer, such as system 100.

In step 1505, consumer registration information may be received by, for example, a system such as system 100. The customer registration information may be similar to that received in steps 1305 and 1405 as discussed with respect to FIGS. 13 and 14, respectively. In step 1510, it may be determined whether information regarding actual resource consumption of a consumer, means of consuming resources and/or external resources regarding resource consumption is available. If one or more of these types of information is available, a message may be prepared using the available information (step 1515). The message may be directed to conservation of resource consumption or a reminder to perform an act, such as adjust the temperature of consumer's house or turn off the lights. If this information is not available then a general message regarding conservation of resource consumption for a consumer may be prepared in a step 1520. In step 1525, the prepared message of steps 1515 or 1520 may be delivered to a consumer via for example an email message, a SMS text message, a website, and/or a document sent through the United States Postal Service.

In step 1530, it may be determined whether the message is recurring. In some instances, the reoccurrence of the message may be set by the consumer or may be determined from the information received in step 1510. In step 1535, the period or frequency of recurring messages may be determined. This may determined by the consumer himself or herself or via some default mechanism. For example, a consumer may decide that he wants to be reminded every morning at 7:30 am to adjust his or her air conditioning or heating because they will be out of the house all day. In this example, the consumer may set the recurrence of a message to “daily at 7:30 am.” In another example, a consumer may wish to be reminded to check the air or water filters on an appliance on a monthly basis. In step 1540, the recurring message may be prepared and in step 1545, the recurring message may be delivered and process 1500 may end.

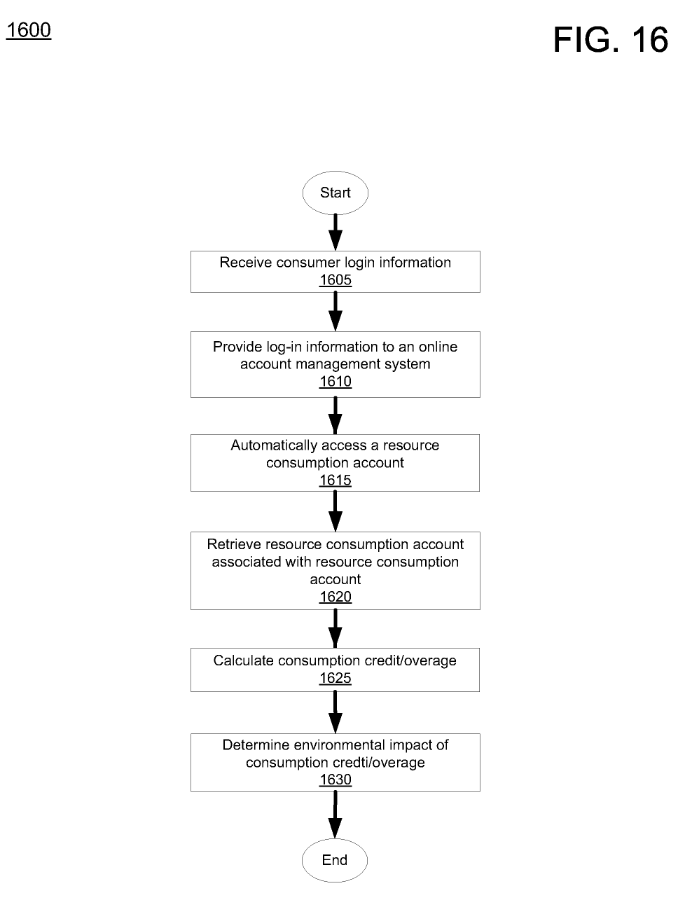

FIG. 16 is a flowchart illustrating a process 1600 for automatically accessing an online resource consumption account and/or retrieving resource consumption information associated with the accessed account. Process 1600 may be executed by a system such as system 100 and/or a third party computer system such as computer system 101.

In step 1605, consumer registration login information associated with a resource consumption account may be received from, for example, a consumer, an agent of the consumer, and/or the resource consumption validator. In step 1610, the received login information may be provided to an online account management system, such as an online bill presentment and/or payment system, maintained by, for example, a resource consumption validator associated with the resource consumption account. Providing that consumer registration information to the online account management system may enable the automatic access to the resource consumption account by, for example, a third party computer system.

Step 1615 can include automatically accessing a resource consumption account with a resource consumption validator via an online account management system associated with the resource consumption validator. The resource consumption account may be associated with the consumer. In step 1620, at least one of actual resource consumption information associated with the consumer, an estimate of actual resource consumption information associated with the consumer and/or historical resource consumption information associated with the consumer may be retrieved automatically from the online consumer account management system. In some cases, process 1600 may end following step 1620.

In step 1625, the retrieved information may be analyzed to determine, for example, resource consumption credit or overage of the current actual resource consumption when compared to the historical actual resource consumption may be calculated. In step 1630, an environmental impact of the resource consumption credit or overage may be determined. This determination may be similar to the determination of step 1025 as shown in FIG. 10 and process 1600 may end.

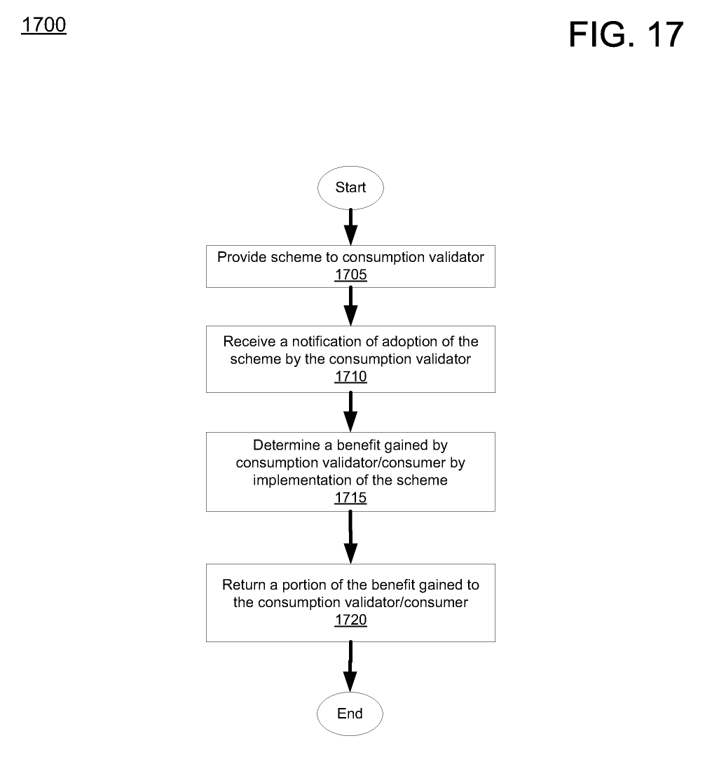

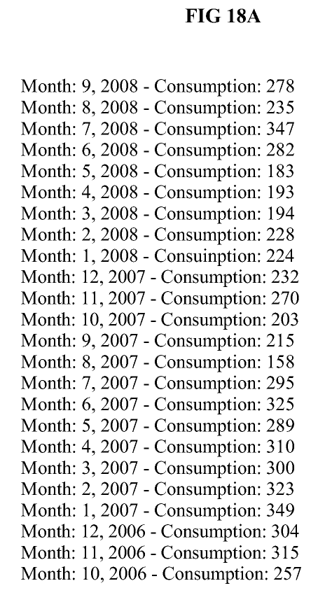

FIG. 17 is a flow diagram illustrating a process 1700 for providing a scheme to a resource consumption validator. Process 1700 may be executed by a system such as system 100 and/or a third party computer system such as computer system 120.

In step 1705, a scheme may be provided to the resource consumption validator maintaining, for example, an online consumption management account. Exemplary schemes include a liability mitigation scheme and an opportunity for economic and/or financial gain. Adoption of the scheme may enable the resource consumption validator to mitigate liability associated with a regulatory scheme affiliated with the consumption of the resource the resource consumption validator validates. Implementation of the scheme may also enable the resource consumption validator to participate in an economic opportunity associated with the consumption and/or conservation of the resource the resource consumption validator validates. In step 1710, a notification of an adoption of the scheme by the resource consumption validator is received.

In step 1715, a benefit gained by the resource consumption validator and/or a consumer associated with the resource consumption validator via implementation of the scheme may be determined. Exemplary benefits include conservation of resources, gains from participation in an economic opportunity, gains from participation in a cap and trade opportunity, reduced liability under a regulatory scheme, and a financial savings or gain. In step 1720, a portion of the benefit gained may be returned to the resource consumption validator and/or consumer.

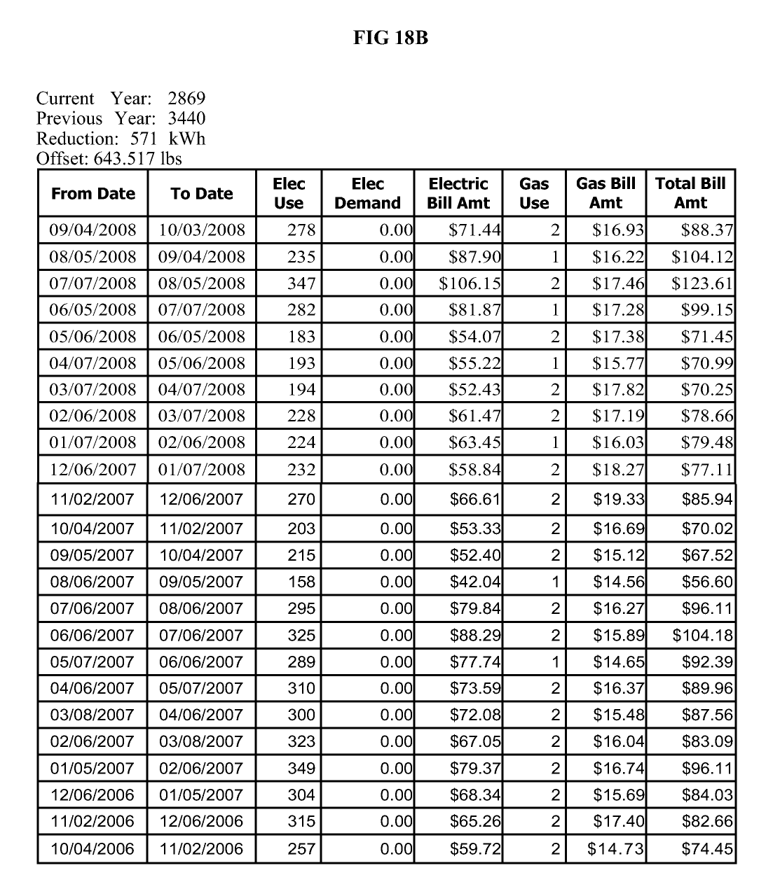

FIGS. 18A and B include an exemplary list and table, respectively, of actual current and historical resource consumption information of a resource consumer received by, for example, a system such as, system 100. The actual resource consumption information included in the tables of FIGS. 18A and B may be representative of the actual and/or historical resource consumption received in steps 1005, 1115, 1205, 1310, and 1420 as discussed with respect to FIGS. 10-14, respectively. The actual resource consumption information may be received from a resource consumption validator, such as resource consumption validator 110. The table includes exemplary entries for a time period of the consumption, the electricity and gas consumption (use), the electric and gas bill dollar amounts due, and a total utility bill dollar amount due.

In some embodiments, the actual resource information may include the source of the resource. For example, a consumer may receive the resource of electricity from three different power plants, each of which has a different efficiency of electricity generation and/or amount of carbon dioxide produced by the power plant per kilowatt/hour. In this example, calculations for the environmental impact of the consumer's electricity consumption, such as the determinations of steps 1025, 1230 as discussed with respect to FIGS. 10 and 12, respectively, may be adjusted, for example, proportionally, to account for the difference in efficiencies and/or carbon dioxide emissions between the three power plants.

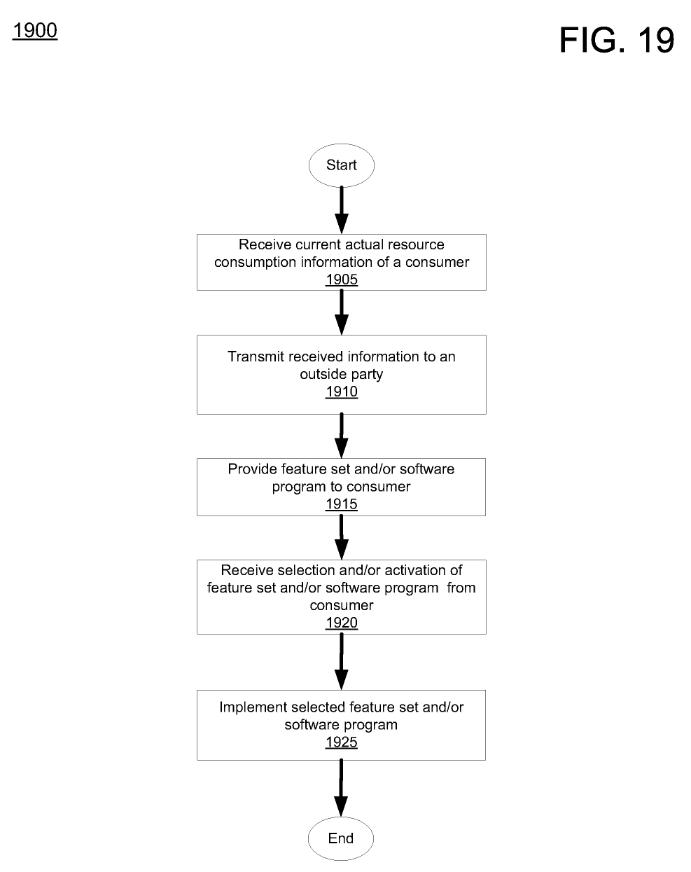

FIG. 19 is a flow diagram illustrating a process 1900 for transmitting received actual resource consumption information to an outside party. Process 1900 may be executed by a system such as system 100 and/or a computer system such as computer system 120.

In step 1905, actual resource consumption information for a consumer, such as consumer 105 may be received. The actual resource consumption information may be received from, for example, a resource consumption validator, such as resource consumption validator 110. In step 1910, the received the received actual resource consumption information may be transmitted to an outside party, such as outside party 175. In some cases, the actual resource consumption information may be received at step 1905 in response to a request from an outside party. The outside party may generate, run and/or maintain a feature set and/or software program independently from, for example, system 100 and/or computer system 120. Exemplary feature sets and/or software programs may enable a consumer to track resource consumption, view and/or select alternative sources for resources to consume, and access statistics and other information regarding resource consumption. Exemplary software programs may include an online service maintained by an outside party wherein the software program has access to information received by a computer system like computer system 120. Exemplary feature sets and/or software programs include alternate resource consumption accounts available via, for example, a web site, widgets, and software programs designed for mobile devices, like mobile phones.

In step 1915, a feature set and/or software program generated, maintained, and/or distributed by the outside party may be provided to the consumer. In step 1920, a selection of a feature set and/or software program may be received from, for example, a consumer or via a default mechanism and in step 1925, the selected feature set and/or software program may be implemented.

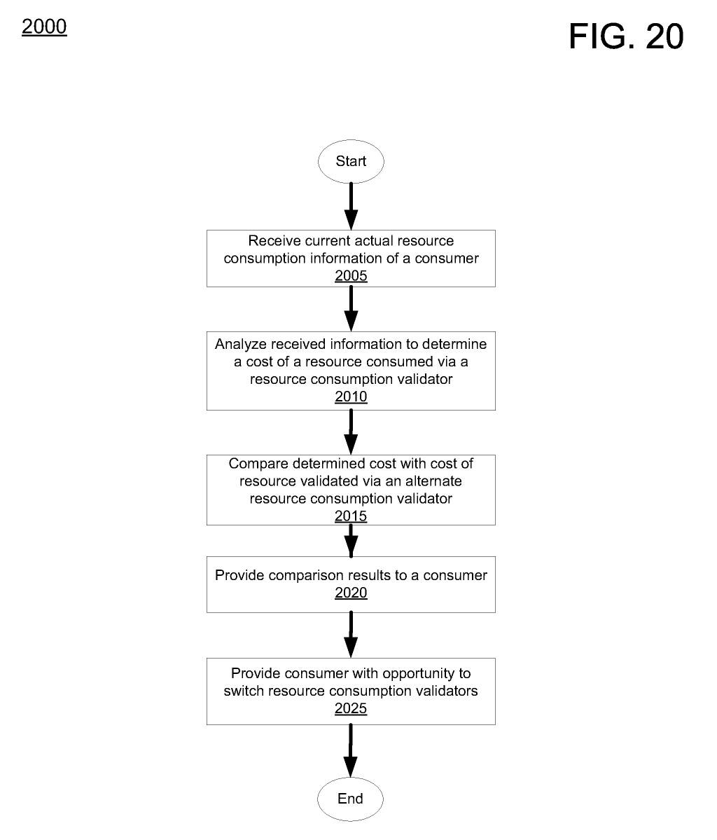

FIG. 20 is a flow diagram illustrating a process 2000 for analyzing received actual resource information to determine a cost associated with the resource consumed. Process 2000 may be executed by a system such as system 100 and/or a computer system such as computer system 120.

In step 2005, actual resource consumption information for a consumer, such as consumer 105 may be received. The actual resource consumption information may be received from, for example, a resource consumption validator, such as resource consumption validator 110. In step 2010, the received actual resource consumption information may be analyzed to, for example, determine a cost associated with the resource consumed. Exemplary costs can include financial costs associated with consumption and/or validation of a resource such as a dollar amount charged per kilowatt/hour of electricity consumed, and a delivery charge for delivering the resource to the consumer. Exemplary costs can also include environmental costs such as environmental cost of producing and/or delivering a resource to a consumer. An exemplary environmental cost may be determined by analyzing a resource validator's rate plan to determine a direct and/or indirect source of the resource to be consumed. Exemplary sources, in the case of electricity can include, but is not limited to, wind power, nuclear power, solar power, landfill gas capture, hydropower, biomass, and coal fired power. The environmental cost of the resource directly consumed may be mitigated by the provider purchasing credits such as renewable energy credits, energy efficient credits, and/or carbon credits.

In step 2015, the determined cost may be compared with a potential cost associated with the resource consumed when the resource is validated and/or provided via an alternative resource consumption validator and or resource provider in order to produce comparison results. For example, in deregulated resource supply markets, a consumer may have a choice between two or more resource consumption validators. The comparison results may show, for example, a cost comparison and/or a projected savings (both financial and environmental) between the various resource consumption validator options available to a consumer. In step 2020, the comparison results may be provided to a consumer.

In step 2025, consumer may be provided an opportunity to switch between two or more resource consumption validators. Step 2025 may include providing a consumer with an opportunity to terminate resource consumption validation with a previously used resource consumption validator, like resource consumption validator 105. Step 2025 may also include providing a consumer an opportunity to activate resource consumption validation with the alternative resource consumption validator, like alternate resource consumption validator 180.

In reviewing this description it should be understood that the present invention is not limited in its application to the details of construction and the arrangement of the components described below or illustrated in the drawings. Indeed, the present invention is capable of being implemented in other embodiments and/or of being practiced or carried out in various ways. Stated differently, the present invention is not intended to be limited by the description of any specific examples or use of any particular illustrations, which examples and illustrations are intended only to enhance understanding of the invention. Also, it is to be understood that the phraseology and terminology employed herein is for the purpose of description and should not be regarded as limiting.

What is claimed is:

1. A method comprising:
receiving, by a third party computer system, actual resource consumption information associated with a consumer from a resource consumption validator;
analyzing, by a third party computer system, the actual resource consumption information by a third party computer system to produce results; and
storing the actual resource consumption information and the results of the analysis in a data store.

2. The method of claim 1, further comprising:
accessing, by a third party computer system, the stored analysis results; and
determining, by a third party computer system, an environmental impact of the consumer's resource consumption based on the analysis results.

3. The method of claim 2, further comprising:
packaging, by a third party computer system, the determined environmental impact by a third party computer system for sale on a market; and
selling the package on a market via a third party computer system.

4. The method of claim 3, further comprising:
returning a portion of the proceeds from the sale of the package to the customer via a third party computer system.

5. The method of claim 2, further comprising:
aggregating the determined environmental impact from two or more consumers by a third party computer system.

6. The method of claim 5, further comprising:
packaging the aggregate by a third party computer system for sale on a market;
selling the package on a market via a third party computer system; and
returning a portion of the proceeds from the sale of the package to the customer via a third party computer system.

7. The method of claim 1, further comprising:
receiving, by a third party computer system, historical resource consumption information associated with the consumer from the resource consumption validator;
calculating, by a third party computer system, a difference in the consumer's resource consumption by comparing the actual resource information and the historical resource consumption information;
calculating, by a third party computer system, a reward for the consumer based on the difference; and
returning the reward to the consumer via a third party computer system.

8. The method of claim 1 further comprising:
preparing, by a third party computer system, a statement for the consumer, wherein the statement includes information regarding the consumer's resource consumption; and
returning the statement to the consumer via a third party computer system via a third party computer system.

9. The method of claim 8, further comprising:
including a message in the statement.

10. The method of claim 1, further comprising:
providing a scheme to the resource consumption validator, by a third party computer system, wherein adoption of the scheme enables the resource consumption validator to perform at least one of mitigating liability associated with a regulatory scheme affiliated with consumption of the resource the resource consumption validator validates and engaging in an economic opportunity associated with consumption of the resource the resource consumption validator validates.

11. The method of claim 10, further comprising:
returning a portion of a benefit gained by the resource consumption validator from enablement of the scheme to at least one of the resource consumption validator and the consumer via a third party computer system.

12. The method of claim 1, further comprising:
transmitting, by a third party computer system, the received actual resource consumption information to an outside party.

13. The method of claim 12, further comprising:
receiving, by the third party computer system, at least one of a feature set and a software program generated by the outside party; and
providing by a third party computer system, at least one of a the feature set and the software program to the consumer.

14. The method of claim 1, wherein the actual resource consumption information is received in response to a request from a third party.

15. The method of claim 1, further comprising:
analyzing, by a third party computer system, the received actual resource consumption information to determine a cost associated with the resource consumed.

16. The method of claim 1, further comprising:
comparing, by a third party computer system, the cost associated with the resource consumed with a potential cost associated with the resource consumed when the resource is validated via an alternative resource consumption validator, to produce comparison results; and
providing, by a third party computer system, the comparison results to the consumer.

17. The method of claim 16, further comprising:
providing, by a third party computer system, the consumer with an opportunity to terminate resource consumption validation with the resource consumption validator and an opportunity to activate resource consumption validation with the alternative resource consumption validator.

18. A method comprising:
accessing, by a third party computer system, a resource consumption account with a resource consumption validator via an online account management system associated with the resource consumption validator, wherein the resource consumption account is associated with a consumer; and
retrieving from the online consumer account management system, by a third party computer system, at least one of actual resource consumption information associated with the consumer, an estimate of actual resource consumption information associated with the consumer, and historical resource consumption information associated with the consumer.

19. The method of claim 18, further comprising:
receiving, by a third party computer system, consumer registration information associated with the resource consumption account from at least one of the consumer, an agent of the consumer, and the resource consumption validator, and
providing the consumer registration information to the online account management system, wherein providing the consumer registration information to the online account management system enables the accessing of the resource consumption account by a third party computer system.

20. The method of claim 18, further comprising:
analyzing, by a third party computer system, the information retrieved from the online account management system; and
determining, by a third party computer system, an environmental impact of the consumer's resource consumption based on the analysis results.

21. The method of claim 20, further comprising:
packaging, by a third party computer system, the determined environmental impact by a third party computer system for sale on a market; and
selling the package on a market via a third party computer system.

22. The method of claim 21, further comprising:
returning a portion of the proceeds from the sale of the package to the consumer via a third party computer system.

23. The method of claim 20, further comprising:
aggregating, the determined environmental impact from two or more consumers by a third party computer system.

24. The method of claim 23, further comprising:
packaging the aggregate for sale on a market by a third party computer system;
selling the package on a market via a third party computer system; and
returning a portion of the proceeds from the sale of the package to the consumer via a third party computer system.

25. The method of claim 18, further comprising:
calculating, by a third party computer system, a difference in the consumer's resource consumption by comparing the retrieved actual resource information and the retrieved historical resource consumption information;
calculating, by a third party computer system, a reward for the consumer based on the difference; and
returning the reward to the consumer via a third party computer system.

26. The method of claim 18 further comprising:
preparing, by a third party computer system, a statement for the consumer, wherein the statement includes information regarding the consumer's resource consumption; and
returning the statement to the consumer via a third party computer system.

27. The method of claim 22, further comprising:
including a message in the statement.

28. The method of claim 18, further comprising:
providing a scheme to the resource consumption validator, by a third party computer system, wherein adoption of the scheme enables the resource consumption validator to perform at least one of mitigating liability associated with a regulatory scheme affiliated with consumption of the resource the resource consumption validator validates and engaging in an economic opportunity associated with consumption of the resource the resource consumption validator validates.

29. The method of claim 28, further comprising:
returning a portion of a benefit gained by the resource consumption validator from enablement of the scheme to a consumer.

30. A graphic user interface (GUI) enabled to:
receive consumer registration information from a consumer;
receive information from the consumer regarding one or more resource consumption accounts the consumer has with one or more resource consumption validators;
provide the consumer with an environmental impact of the consumer's resource consumption associated with the one or more resource consumption accounts; and
provide the consumer with information regarding a reward based on the environmental impact.

31. A computer readable media wherein the computer readable media includes instructions that enable a machine to perform the following operations:
receive actual resource consumption information associated with a consumer from a resource consumption validator;
analyze the information by a third party computer system;
determine an environmental impact of the consumer's resource consumption based on the analysis results; and
store the received information, the results of the analysis, and the determined environmental impact.
